(19) United States
(12) Patent Application Publication
(10) Pub. No.: US 2019/0095507 A1
(43) Pub. Date: Mar. 28, 2019

(54) SYSTEMS AND METHODS FOR AUTONOMOUS DATA ANALYSIS

(71) Applicant: appli Inc., Denver, CO (US)

(72) Inventors: Pierre Elisseeff, Cincinnati, OH (US); Curtis Ray Eubanks, Lakewood, CO (US); Robert Brian Seigel, Denver, CO (US)

(21) Appl. No.: 16/141,751

(22) Filed: Sep. 25, 2018

Related U.S. Application Data
(60) Provisional application No. 62/625,645, filed on Feb. 2, 2018.
(60) Provisional application No. 62/562,910, filed on Sep. 25, 2017.

(51) Int. Cl. G06F 17/30; G06N 99/00; G06Q 10/06

(52) U.S. Cl. CPC G06F 17/30569; G06F 17/30958; G06Q 10/067; G06N 99/005; G06F 17/30572

(57) ABSTRACT

The present disclosure relates to systems for providing information in an automated or semi-automated manner, through use of one or more autonomous virtual analysts. In one embodiment, the autonomous virtual analysts may perform many of the same functions as a human analyst, and provide business intelligence relating to revenue, income, profit, loss, expenses, historical data, projections, trends, comparative analysis, etc. In embodiments, the autonomous virtual analyst may be employed through use of natural language dialog with a user, and further configured to capture and appropriately respond to the context of the dialog by supplying a user with information pertinent to the request. According to varying embodiments, a variety of decision trees comprising a plurality of nodes is disclosed. In varying embodiments, the system may comprise one or more distinct modules, including a driver graph module. Methods of automatically and near-instantaneously providing information in response to a user inquiry are also disclosed.

### CROSS-REFERENCE TO RELATED APPLICATIONS

This application claims priority to and the benefit under 35 U.S.C. § 119(e) to U.S. Provisional Patent Application Ser. No. 62/625,645 filed Feb. 2, 2018, and U.S. Provisional Patent Application Ser. No. 62/562,910 filed Sep. 25, 2017, which are both incorporated by reference in their entireties.

### FIELD OF THE INVENTION

The present invention is generally directed toward systems and methods for analyzing metrics, and more specifically to systems and methods for autonomously analyzing, processing and supplying information in response to an inquiry, instruction or command.

### COPYRIGHT NOTICE

A portion of this disclosure is subject to copyright protection. Limited permission is granted to facsimile reproduction of the patent document or patent disclosure as it appears in the U.S. Patent and Trademark Office (USPTO) patent file or records. The copyright owner reserves all other copyright rights whatsoever.

### BACKGROUND OF THE INVENTION

Business and finance-related systems contain information in a variety of different manners, and increasingly contain a quantity of data that makes it difficult, if not impossible, for an individual (or multiple individuals) to quickly retrieve and analyze. Such information may be derived from a source document or from several sources of data, updated on a daily, weekly or monthly basis, and in some instances may be updated constantly or involve streaming data. This information may be organized according to one or more formats or systems, further complicating the retrieval and analysis of such information.

Large data sets concerning financial and/or business intelligence are increasingly being reviewed and modified, often by numerous individuals across multiple divisions, departments and organizations, causing further difficulties. Current business analytical approaches are often highly customized for the data source and structure being analyzed. Accordingly, current analysts treat these data sets as largely immutable, and therefore adapt a broad variety of analytical techniques to suit the business task at hand. This creates discrepancies between one analytical approach and another, which in turn can create discrepancies when attempting to merge the analysis performed by one analyst with another, particularly where the analysts have different respective objectives.

Current state of the art business intelligence systems provide a lot of data to users, but such systems have limited or no intelligence to perform analytical tasks. At most, such systems comprise stand-alone, predictive analytic capabilities typically used for scoring (lead scoring, retention scoring, credit scoring, propensity modeling, in some cases media attribution), or broad pattern recognition (network breach detection, network security analysis). These systems are complex, reactive, and require significantly more resources to operate. Further, these systems are hard to scale, particularly when overwhelmed with data, as those or skill with Hadoop systems are familiar.

Outside of business intelligence systems, certain applications exist that can provide assistance with general tasks, such as setting reminders or navigating through a metropolitan area. However, such applications are generally limited in the number of voice commands and simple queries those applications are able to interpret, and do not engage in ongoing dialog or maintain context over time. Prior art applications also require significant training to understand a user's commands and maintain the context necessary to engage in bidirectional or other complex communications with a human user, or fail to provide meaningful analysis and processing of data in the manner equivalent to a business or financial analyst. Further, there are a number of shortcoming in the art with respect to a user's ability to access and analyze such information quickly and efficiently, so that information necessary to make business or financial-related decisions is possible in real (or near real) time.

Furthermore, current systems and methods for providing business insights are time consuming and inefficient, including insights provided in the form of memos, presentations, dashboards, charts, etc. For example, key performance indicators (KPI) in present displays are often hard to use, especially when incorporating large amounts of data. As a result, current business and financial analysts are forced to manually browse charts and reports containing up to hundreds of thousands of data points, while simultaneously attempting to derive meaning from and discern the relationships among those data points. While attempts have been made to display large amounts of data (including business and financial data) to a user, such prior art displays suffer from numerous disadvantages. Those disadvantages include requiring a user to manually define and manage a large number of data points, lack of automation in creating the display, inability to recognize anomalies or determine root causes, lack of dimensional and cross-dimensional relationships between data points, difficulties in managing scale and density of the data represented in the display, and other shortcomings.

It would therefore be beneficial to provide an autonomous, virtual agent or analyst that is capable of providing intelligent, analytical processing of information contained in one or more business intelligence systems, and which otherwise can provide the needed business intelligence in an efficient and timely manner. It would also be beneficial to display data and analysis in a graphical format that is autonomously or semi-autonomously generated and solves the shortcomings of prior art displays outlined above.

It is with respect to the above issues and other problems presently faced by those of skill in the pertinent art that the embodiments presented herein were contemplated.

### SUMMARY OF THE INVENTION

The present disclosure relates to systems and methods that overcome the problems identified above. While several advantages of the system and method of one embodiment are provided in this section, this Summary is neither intended nor should it be construed as being representative of the full extent and scope of the present invention. The present invention is set forth in various levels of detail in the Summary as well as in the attached drawings and in the Detailed Description, and no limitation as to the scope of this disclosure is intended by either the inclusion or non-inclusion of elements, components, etc. in the Summary. Additional aspects of the present disclosure will become more readily apparent from the detailed description.

The systems and methods described herein are, according to preferred embodiments, optimized for streamlining and automating one or more analytical tasks, such as: (1) anomaly detection, (2) correlation, (3) forecasting, (4) structure learning. According to alternate embodiments, additional analytical tasks are disclosed for use with the systems and methods described herein.

The foregoing systems and methods preferably comprise a subsystem referred to herein in varying embodiments as a driver graph. The driver graph preferably captures and presents a normally complex and interwoven series of “nodes” into an easily readable and navigable graphical representation. The incorporation of driver graphs, and autonomous and semi-autonomous virtual analysts described below, removes a significant resource burden from business and financial analysts, among other analysts. For instance, the use of the novel driver graph topology described herein removes the time-consuming task of customizing business and/or financial analytics, and permits an analyst to focus on manipulating, interpreting or updating the driver graph. The amount of data that can be analyzed is also greatly increased through the use of well-designed interfaces. Furthermore, the creation of a driver graph may be largely or completely autonomous, thereby permitting users to create graphs for data sets that are far too large to build manually.

According to one aspect of the present disclosure, systems and methods described in detail herein provide a user with autonomous virtual analyst(s) (“AVA”) capable of completing a variety of tasks upon receiving an inquiry, instruction or command from a user. In embodiments disclosed herein, a AVA may substitute for or otherwise provide the equivalent functions of a financial or business analyst, with the capabilities to interpret, analyze, compare, contrast, extrapolate, project or otherwise process information to provide the user with valuable business intelligence in a convenient, useable format.

According to another aspect, systems and methods are described for automatically initiating and conducting business or financial analysis, or to make, track and approve modifications to that analysis, reconcile those modifications, and ultimately approve and/or finalize that analysis through the use of one or more autonomous virtual analysts. In embodiments, the business or financial analysis data set may be accessed several times by several different individual users, and may involve a plurality of autonomous virtual analysts.

It is yet another aspect to provide a user with an efficient way to obtain business intelligence with respect to data contained in one or more data repositories and modify the business intelligence through creation of one or more reports. By analyzing a larger set of data sources and combining them in a novel manner, the systems and methods described herein are configured to point out data relationships to the analyst that may inform the analyst's own work and downstream analysis, further enabling the analyst to adapt or modify the system to get to better, more relevant and more timely insights to other users in the business.

In yet another aspect, the system and methods described herein comprise a convenient, integrated interface or display for a user to view the status or performance of one or more metrics. In certain embodiments, the interface may also comprise an automated assessment and/or proof-points or other insights, which are displayed in an efficient and easy to understand manner. The interface(s) further provide the user with the option of automatically generating a business presentation with said insights in a fraction of the time it takes to complete such tasks manually.

In yet a further aspect of the present disclosure, a computer readable storage medium comprising processor executable instructions operable to utilize the system or perform the methods is provided.

It is to be expressly understood that the ensuing description provides embodiments only, and is not intended to limit the scope, applicability, or configuration of the claimed invention. Rather, the ensuing description will provide those skilled in the art with an enabling description for implementing the embodiments. It should be understood that various changes may be made in the function and arrangement of elements without departing from the spirit and scope of the appended claims.

Furthermore, while embodiments of the present disclosure will be described in connection with various examples of business intelligence data and information, it should be appreciated that embodiments of the present disclosure are not so limited. In particular, embodiments of the present disclosure may be applied to a variety of information and/or data sources. For instance, while embodiments of the present invention may be described with respect to finance-related inquiries, other applicability is contemplated.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “automated”, “automatically”, “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “machine-readable media” or “computer-readable media” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a flexible disk, hard disk, magnetic tape, or any other magnetic medium, magneto-optical medium, a CD-ROM, any other optical medium, a RAM, a PROM, an EPROM, a FLASH-EPROM, a solid state medium like a memory card, any other memory chip or cartridge, or any other medium from which a computer or like machine can read.

When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The term “data source” or “data repository” as used herein refers to any one or more of a device, media, component, portion of a component, collection of components, and/or other structure capable of storing data accessible to a processor. Examples of data sources contemplated by this definition include, but are not limited to, processor registers, on-chip storage, on-board storage, hard drives, solid-state devices, fixed media devices, removable media devices, logically attached storage, networked storage, distributed local and/or remote storage (e.g., server farms, “cloud” storage, etc.), media (e.g., solid-state, optical, magnetic, etc.), and/or combinations thereof.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, machine engine, artificial intelligence, fuzzy logic, or combination of hardware and software that is capable of performing the functionality associated with that element.

While the invention is described in terms of exemplary embodiments, it should be appreciated that individual aspects of the invention may be separately claimed.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosure.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein. In the drawings:

FIG. 1 illustrates a system architecture and various elements of the systems and methods described herein in accordance with embodiments of the present disclosure;

FIG. 2 is a schematic diagram illustrating a driver graph ingestion and inflation in accordance with embodiments of the present disclosure;

FIG. 3A illustrates an exemplary topology for a driver graph in accordance with embodiments of the present disclosure;

FIG. 3B illustrates various categories and subcategories of analytics to be performed by the systems and methods in accordance with embodiments of the present disclosure;

FIG. 3C illustrates exemplary business and financial analytics capable of being performed by the systems and methods described herein in accordance with embodiments of the present disclosure;

FIG. 4A illustrates one taxonomy for a driver graph and an exemplary arrangement of nodes in accordance with embodiments of the present disclosure;

FIG. 4B illustrates the node-link relationships in accordance with the embodiment shown in FIG. 4A;

FIG. 5A illustrates another taxonomy for a driver graph and arrangement of nodes in accordance with embodiments of the present disclosure;

FIG. 5B illustrates the logical node-link relationship in accordance with the embodiment shown in FIG. 5A;

FIG. 6A illustrates another taxonomy for a driver graph and arrangement of nodes in accordance with embodiments of the present disclosure;

FIG. 6B illustrates the logical node-link relationship in accordance with the embodiment shown in FIG. 6A;

FIG. 7A illustrates another taxonomy for a driver graph and arrangement of nodes in accordance with embodiments of the present disclosure;

FIG. 7B illustrates the logical node-link relationship in accordance with the embodiment shown in FIG. 7A;

FIG. 8A illustrates another taxonomy for a driver graph and arrangement of nodes in accordance with embodiments of the present disclosure;

FIG. 8B illustrates the logical node-link relationship in accordance with the embodiment shown in FIG. 8A;

FIG. 9A illustrates another taxonomy for a driver graph and arrangement of nodes in accordance with embodiments of the present disclosure;

FIG. 9B illustrates the logical node-link relationship in accordance with the embodiment shown in FIG. 9A;

FIG. 10A illustrates another taxonomy for a driver graph and arrangement of nodes in accordance with embodiments of the present disclosure;

FIG. 10B illustrates the logical node-link relationship in accordance with the embodiment shown in FIG. 10A;

FIG. 11A illustrates another taxonomy for a driver graph and arrangement of nodes in accordance with embodiments of the present disclosure;

FIG. 11B illustrates the logical node-link relationship in accordance with the embodiment shown in FIG. 11A;

FIG. 12A illustrates another taxonomy for a driver graph and arrangement of nodes in accordance with embodiments of the present disclosure;

FIG. 12B illustrates the logical node-link relationship in accordance with the embodiment shown in FIG. 12A;

FIG. 13 illustrates an exemplary method for generating a primary driver graph in accordance with embodiments of the present disclosure;

FIG. 14 illustrates an exemplary method for ingesting data and generating a driver graph in accordance with embodiments of the present disclosure;

FIG. 15 illustrates an exemplary method for generating dimensional hierarchies for a driver graph in accordance with embodiments of the present disclosure;

FIG. 16A illustrates a topology for a driver graph display and arrangement of nodes in accordance with embodiments of the present disclosure;

FIG. 16B illustrates the core analytics for identifying the structure of the driver graph shown in FIG. 16A;

FIG. 17A illustrates yet another topology for a driver graph display and arrangement of nodes in accordance with embodiments of the present disclosure;

FIG. 17B illustrates the core analytics for identifying the structure of the driver graph shown in FIG. 17A;

FIG. 18 illustrates an exemplary method for assessing potential anomalies in accordance with embodiments of the present disclosure;

FIG. 19A illustrates yet another topology for a driver graph display and arrangement of nodes in accordance with embodiments of the present disclosure;

FIG. 19B illustrates the core analytics for correlating nodes in the driver graph shown in FIG. 19A;

FIG. 20 illustrates an exemplary method for detecting and correlating changes in the driver graph structure in accordance with embodiments of the present disclosure;

FIG. 21A illustrates yet another topology for a driver graph display and arrangement of nodes in accordance with embodiments of the present disclosure;

FIG. 21B illustrates the core analytics for forecasting in view of the state of the driver graph shown in FIG. 21A;

FIG. 22 illustrates an exemplary display in accordance with embodiments of the present disclosure;

FIG. 23 illustrates another exemplary display in accordance with embodiments of the present disclosure;

FIG. 24 illustrates yet another exemplary display in accordance with embodiments of the present disclosure;

FIG. 25 illustrates yet another exemplary display in accordance with embodiments of the present disclosure;

FIG. 26 illustrates yet another exemplary display in accordance with embodiments of the present disclosure;

FIG. 27 illustrates yet another exemplary display in accordance with embodiments of the present disclosure;

FIG. 28 illustrates an exemplary user interface in accordance with embodiments of the present disclosure;

FIG. 29 illustrates another user interface in accordance with embodiments of the present disclosure;

FIG. 30 illustrates another user interface in accordance with embodiments of the present disclosure;

FIG. 31 illustrates another user interface in accordance with embodiments of the present disclosure;

FIG. 32 illustrates an analytical diagram in accordance with embodiments of the present disclosure;

FIG. 33 illustrates another analytical diagram in accordance with embodiments of the present disclosure;

FIG. 34 illustrates another analytical diagram in accordance with embodiments of the present disclosure;

FIG. 35 illustrates another analytical diagram in accordance with embodiments of the present disclosure;

FIG. 36 illustrates another analytical diagram in accordance with embodiments of the present disclosure;

FIG. 37 illustrates another analytical diagram in accordance with embodiments of the present disclosure;

FIG. 38 illustrates another analytical diagram in accordance with embodiments of the present disclosure;

FIG. 39 illustrates another analytical diagram in accordance with embodiments of the present disclosure;

FIG. 40 illustrates another analytical diagram in accordance with embodiments of the present disclosure;

FIG. 41 illustrates another analytical diagram in accordance with embodiments of the present disclosure; and

FIG. 42 illustrates another analytical diagram in accordance with embodiments of the present disclosure.

### DETAILED DESCRIPTION

The present disclosure, in varying embodiments described in this Detailed Description, relates to systems and methods for supplying information to a user through one or more autonomous virtual analysts (“AVA”). In embodiments disclosed herein, an AVA may substitute for or otherwise provide the equivalent functions of a financial or business analyst. In embodiments, each AVA has the capability to interpret, analyze, compare, contrast, extrapolate, project or otherwise process information, either at the instruction of the user or not, and provide the user with valuable business intelligence in a convenient, timely and otherwise useable format.

In embodiments, the systems and methods disclosed herein provide information to a user in an automated or semi-automated manner, through use of one or more AVAs. In one embodiment, the AVAs provide analysis and business intelligence relating to revenue, income, profit, loss, expenses, historical data, projections, trends, comparative analysis, etc. Methods of automatically and near-instantaneously (i.e., near real-time) providing information in response to a user inquiry are also disclosed herein.

In other embodiments, the AVAs may be adaptive and learn new functions or acquire additional knowledge through the course of interactions with a user. In yet other embodiments, several AVAs may be provided with distinct or partially overlapping capabilities, and in certain embodiments are configured to communicate and interact with one another to more efficiently process requests from the user(s) and provide information relevant to the user(s) request.

In embodiments, an AVA may further comprise the capability to supply the user with specific reports, graphs, analysis and insights in a predetermined or independent manner. In other embodiments, the AVA may be configured to automatically determine the appropriate reporting and analysis to supply to the user in response to an inquiry, instruction or command, including through the use of driver graph logic described in greater detail below. In still other embodiments, the AVA possesses the capability to engage in natural language dialog with one or more users and receive and understand various inquiries, instructions and commands. In varying embodiments, the AVA may engage in context-based dialog with a user.

In embodiments, the AVA may be further configured to perform historical context analysis and determine whether other users are making similar or related requests, thereby reducing processing and analyzing time required to provide the requested information. In embodiments, the AVA may report to a primary user that number of instances in which multiple requests for the same reports or information have occurred within a set time period.

In embodiments, the system and each AVA is advantageously configured to receive and send information by, for example, a user's mobile device. The system is also preferably configured to generate a plurality of reports, graphs, insights, etc. Such reports, graphs and insights may be used by the user to improve strategy and decision-making, to locate a particular dataset, template or sample from the data repository, or to facilitate reconciliation of different versions of a report, graph or other insight.

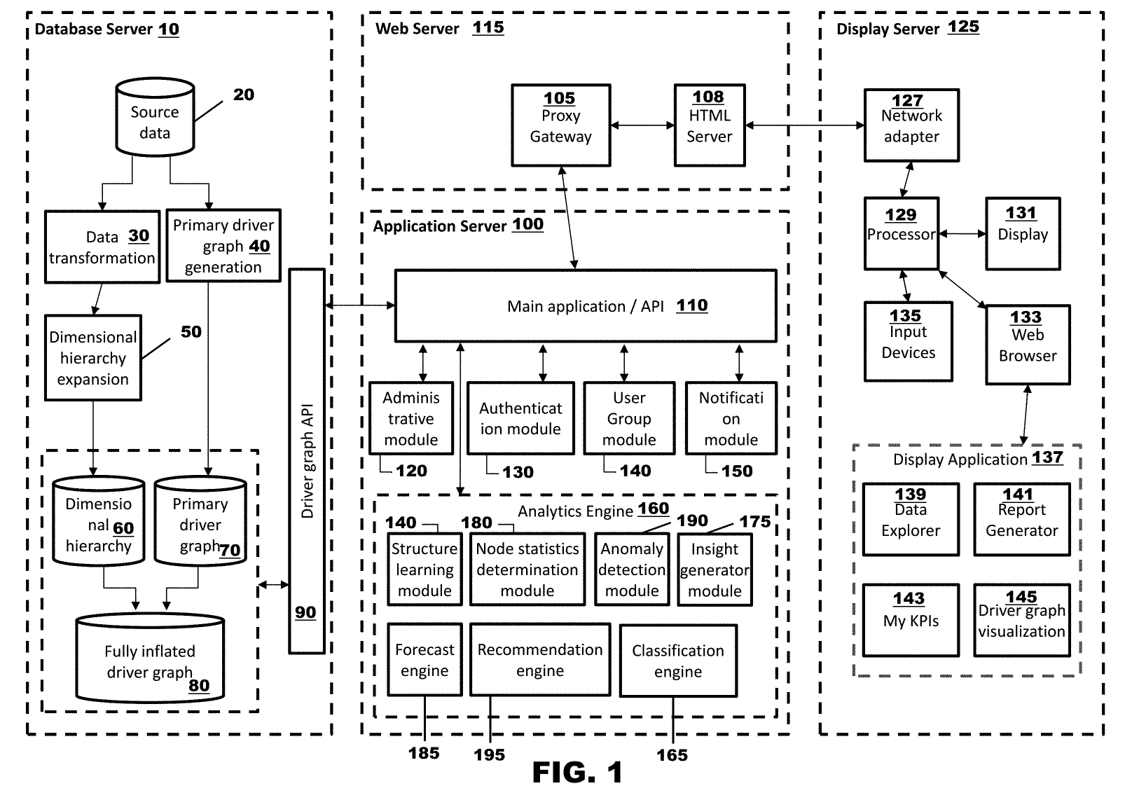

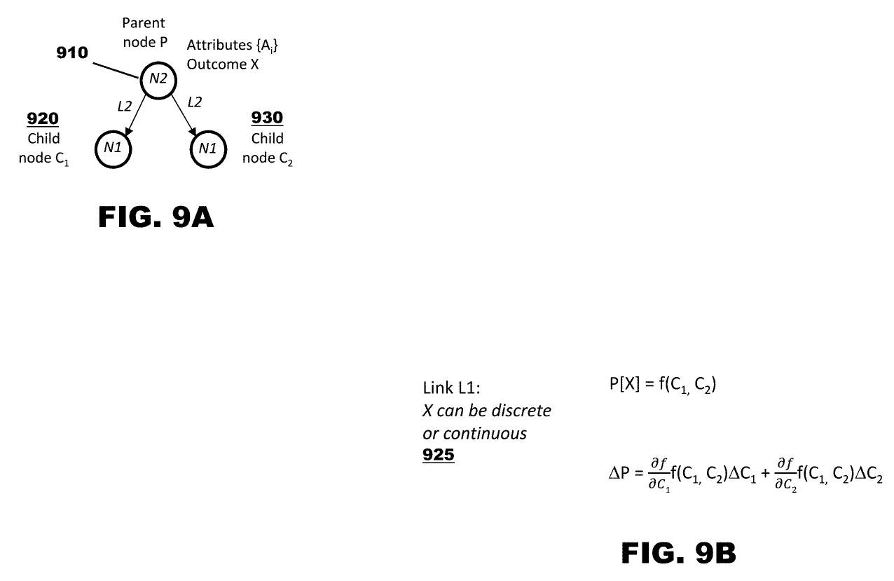

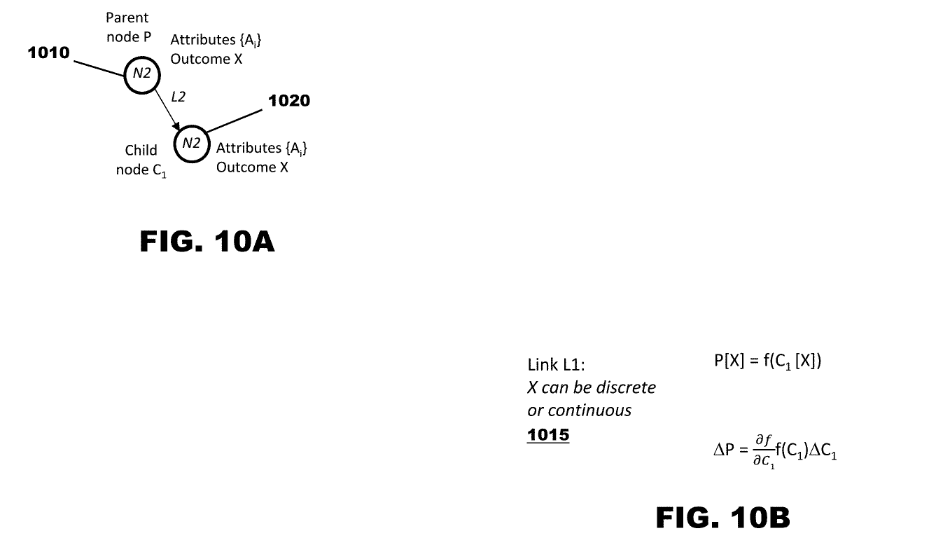

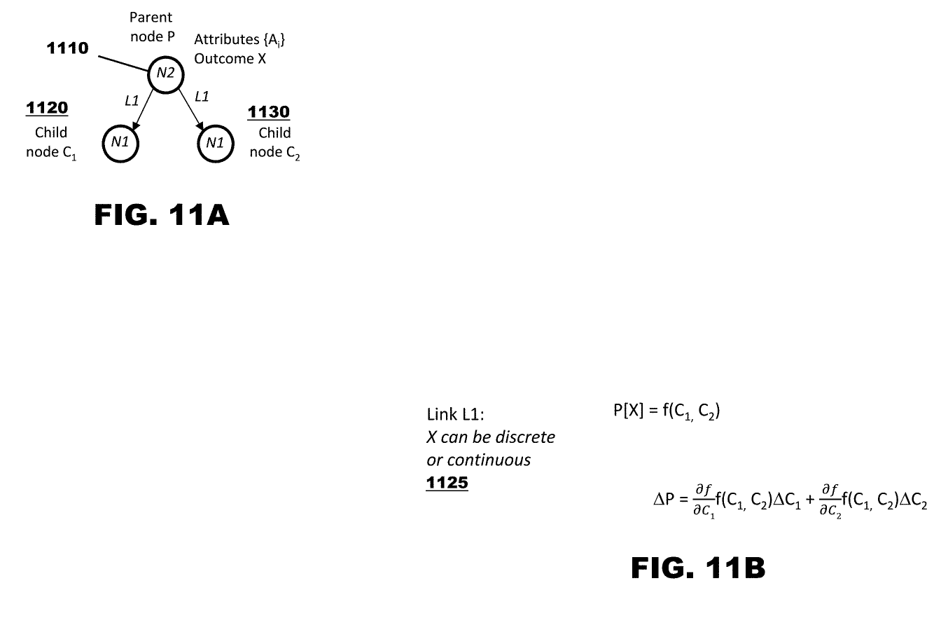

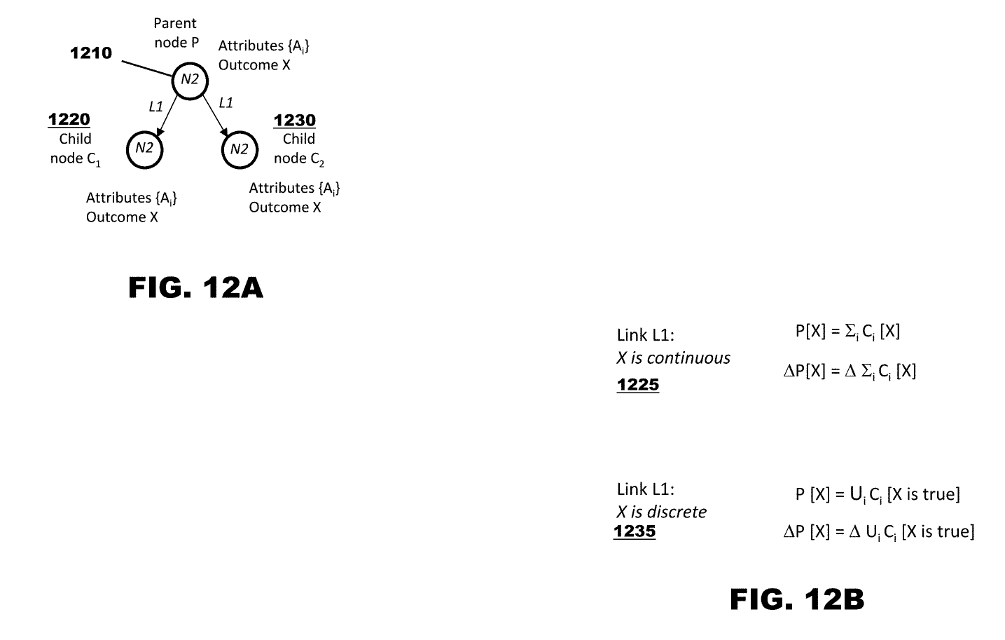

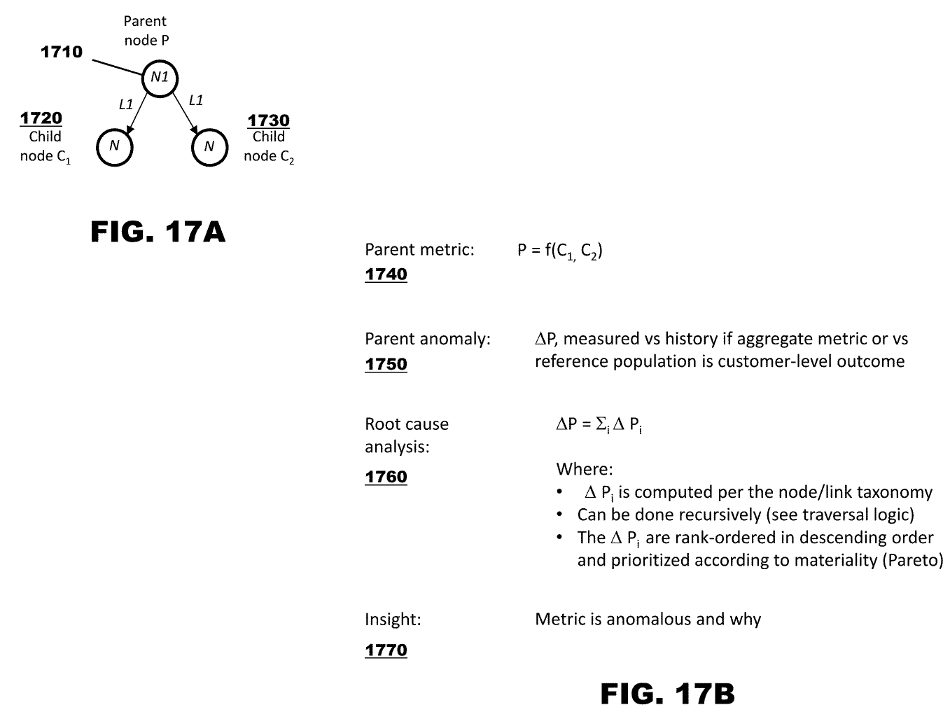

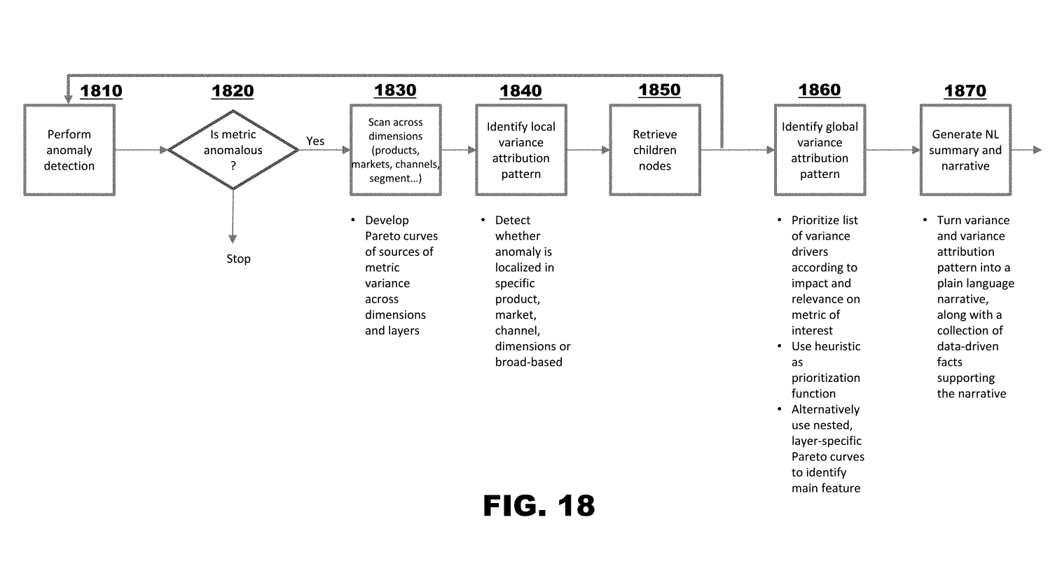

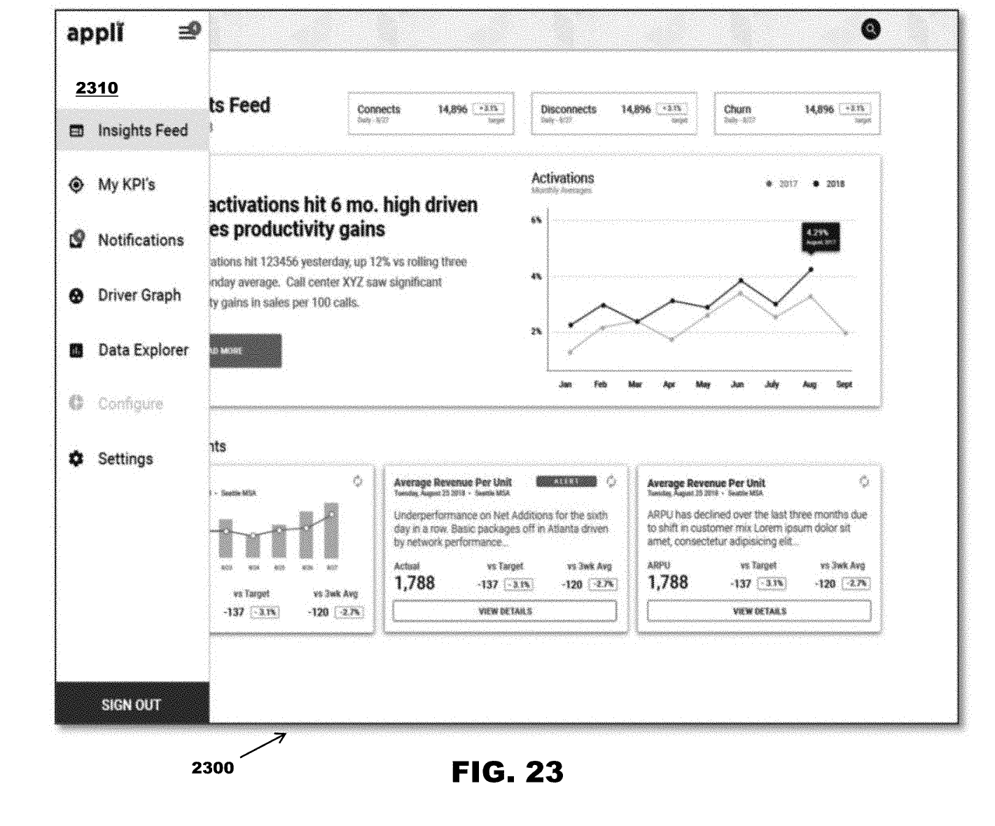

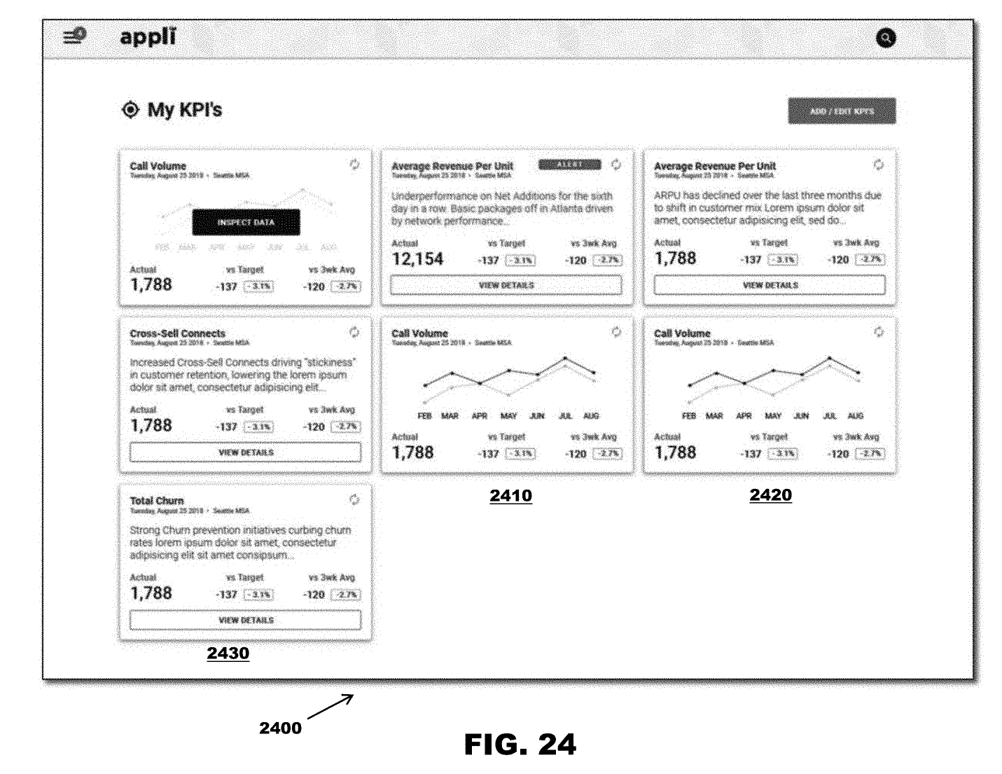

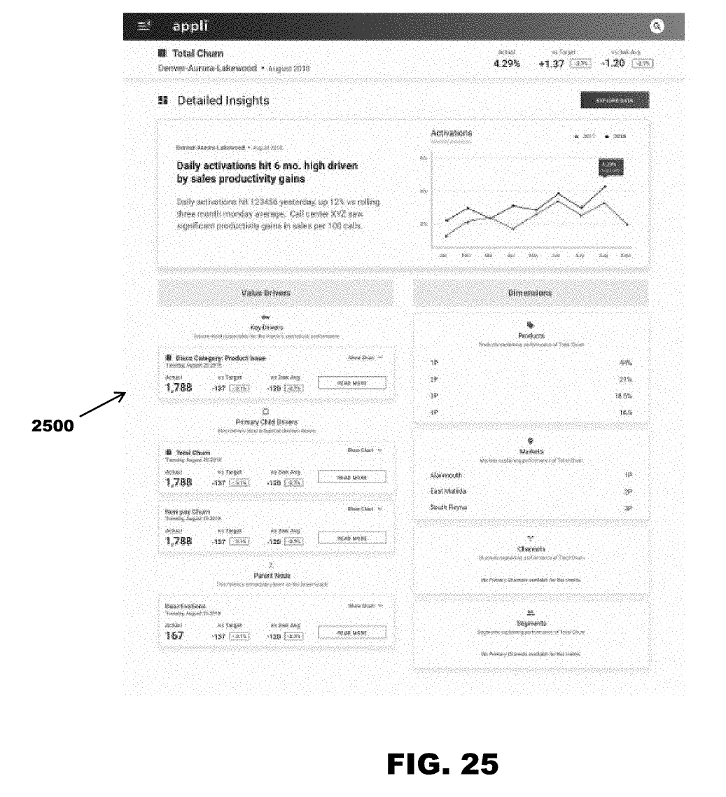

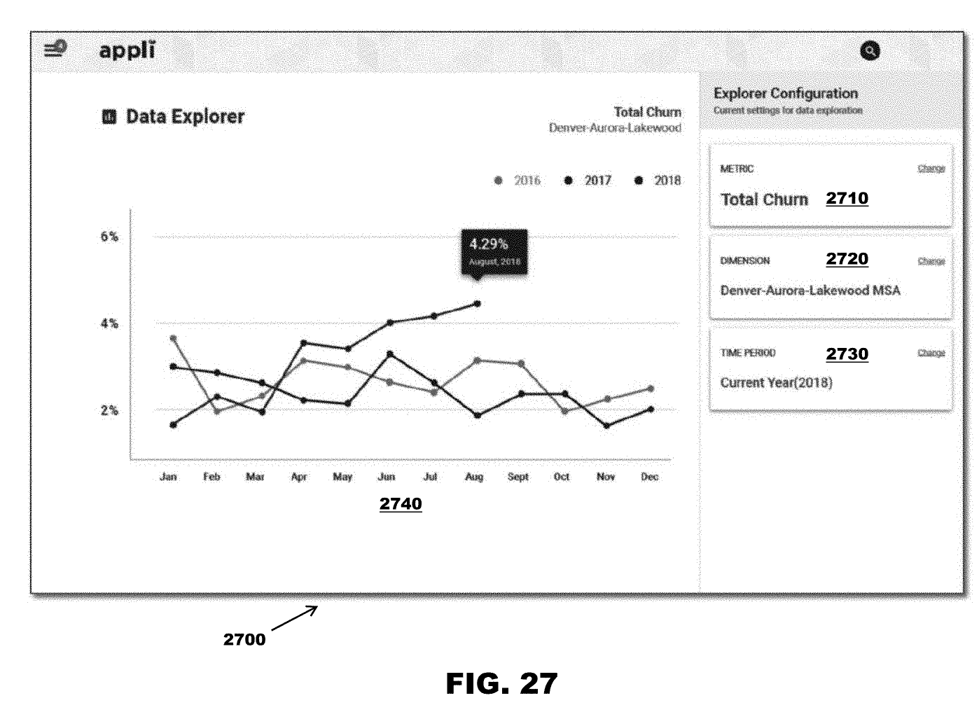

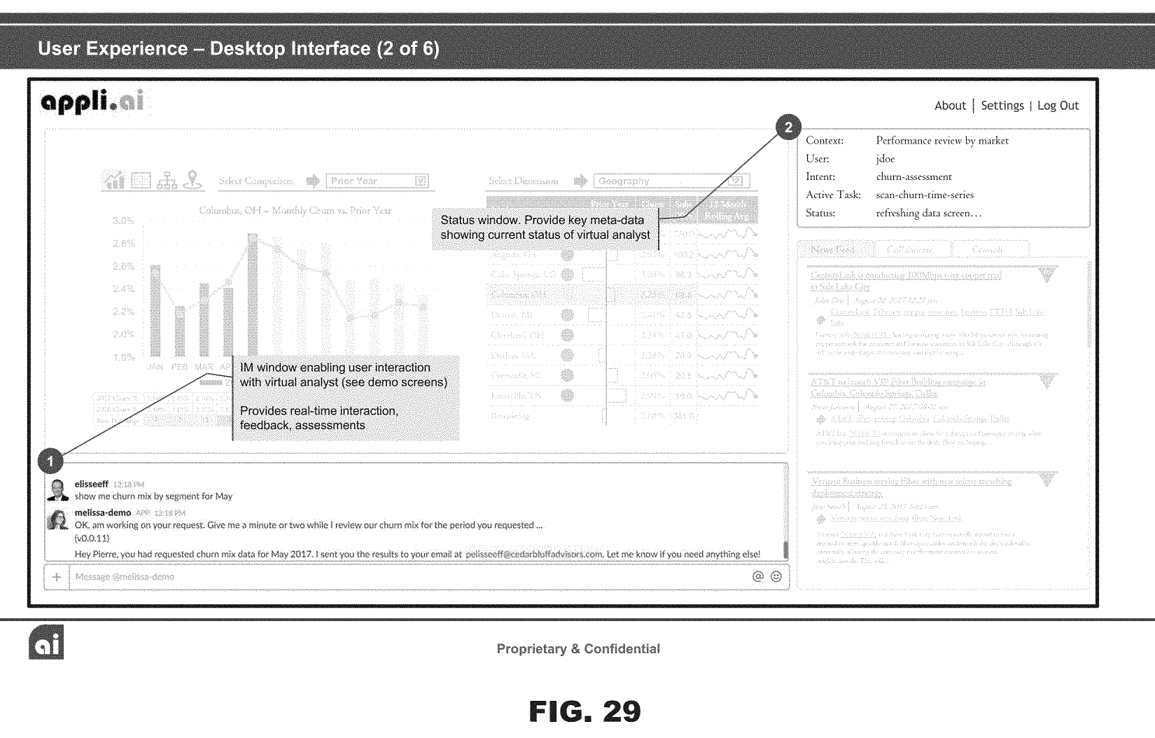

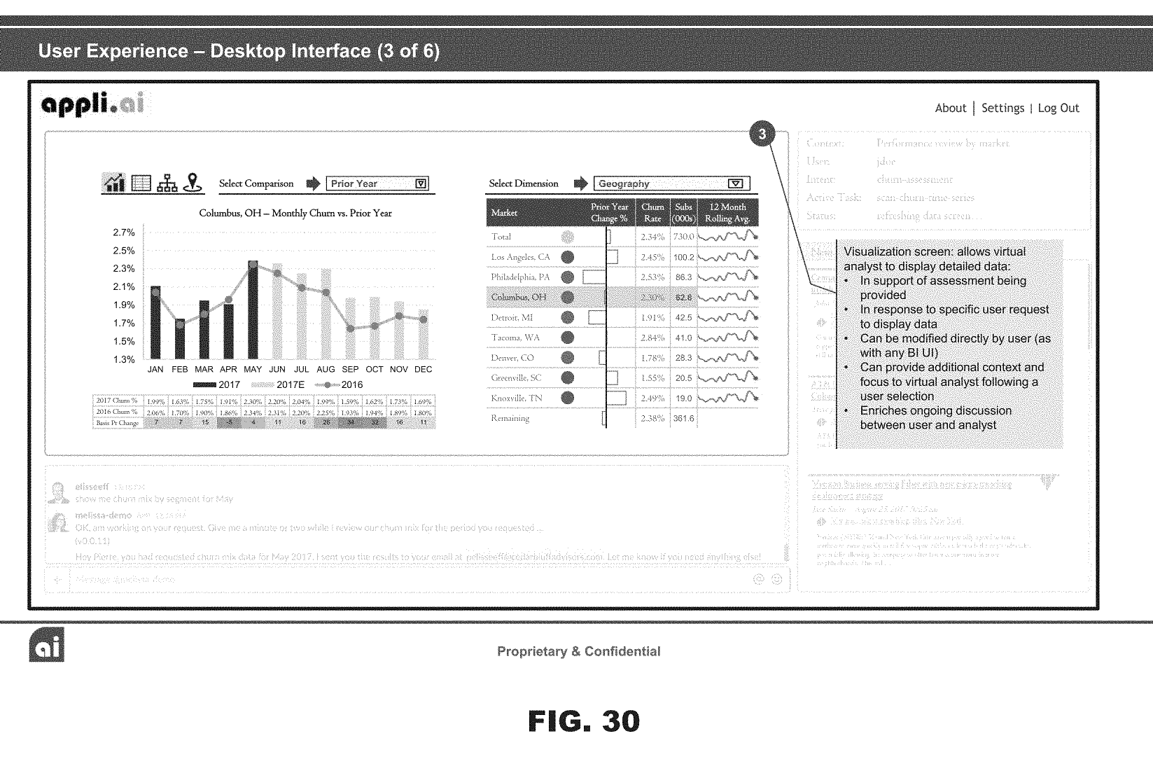

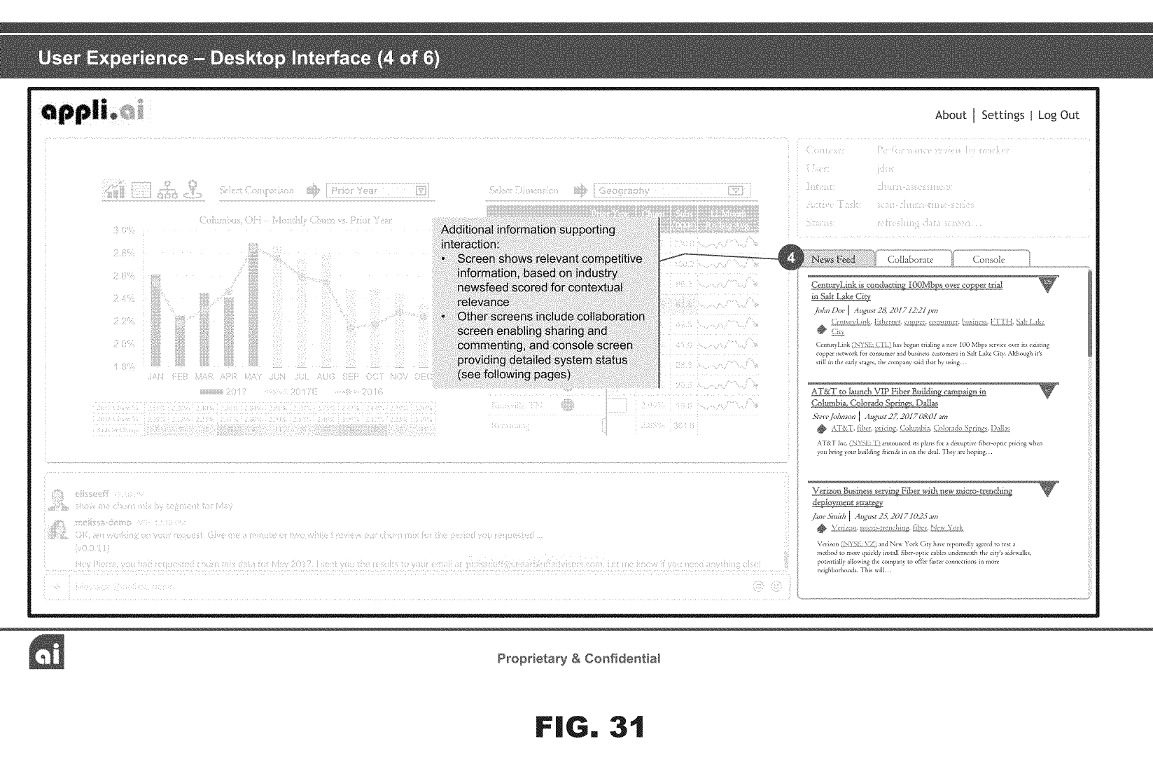

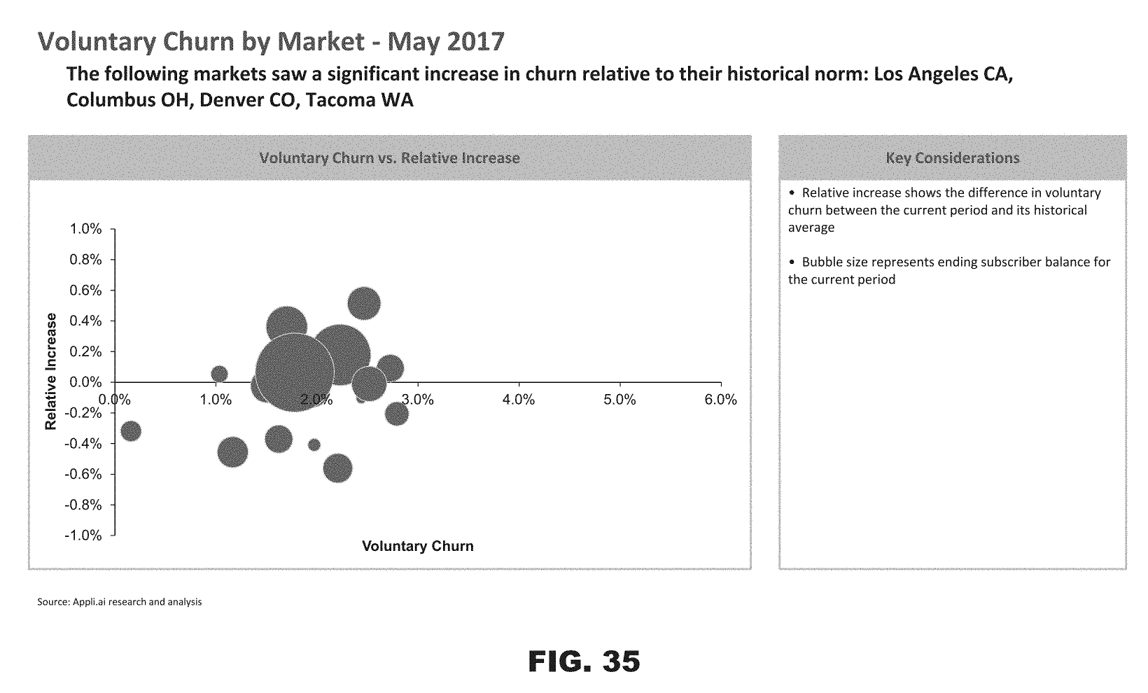

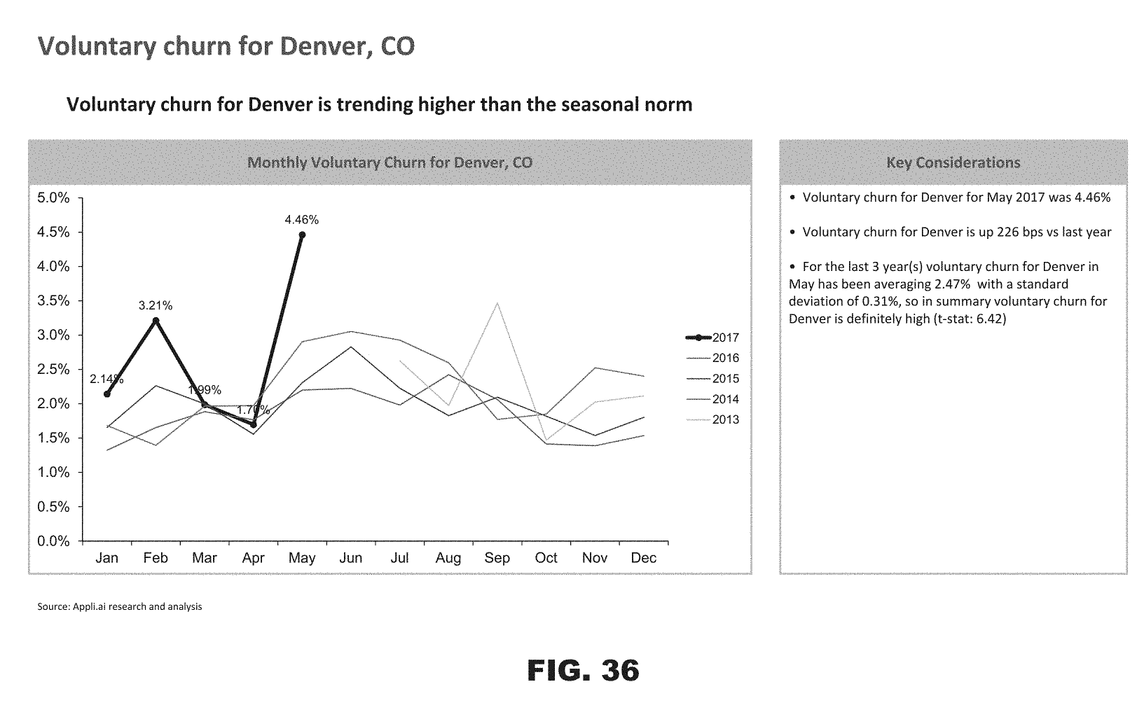

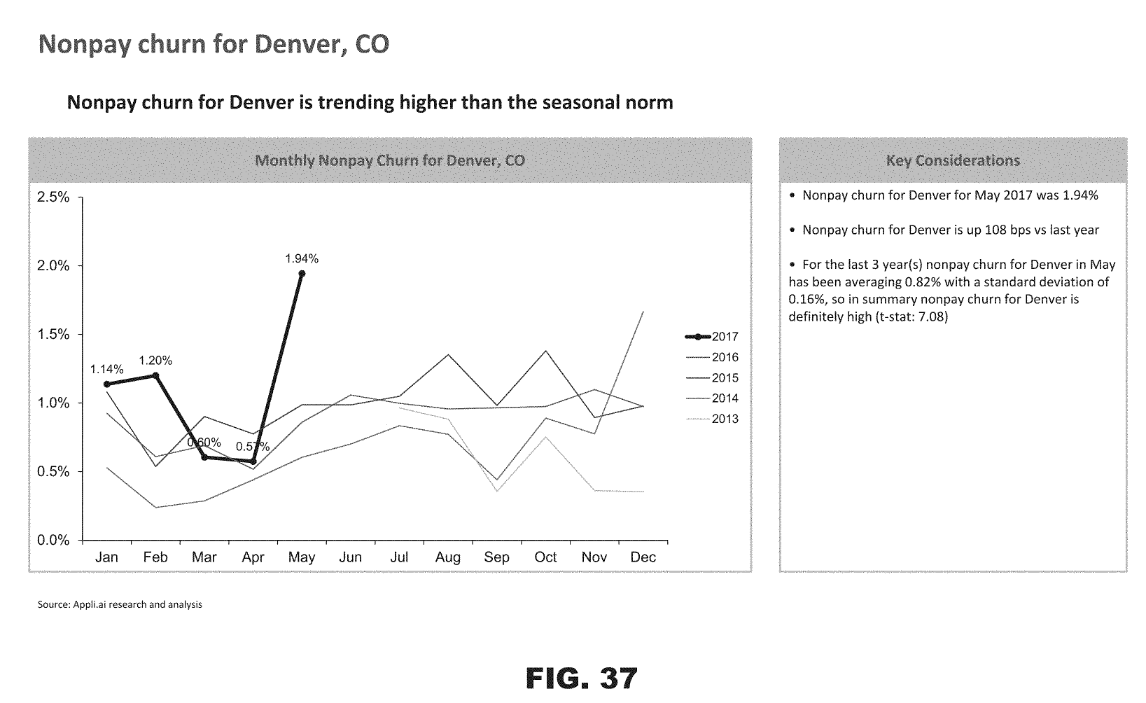

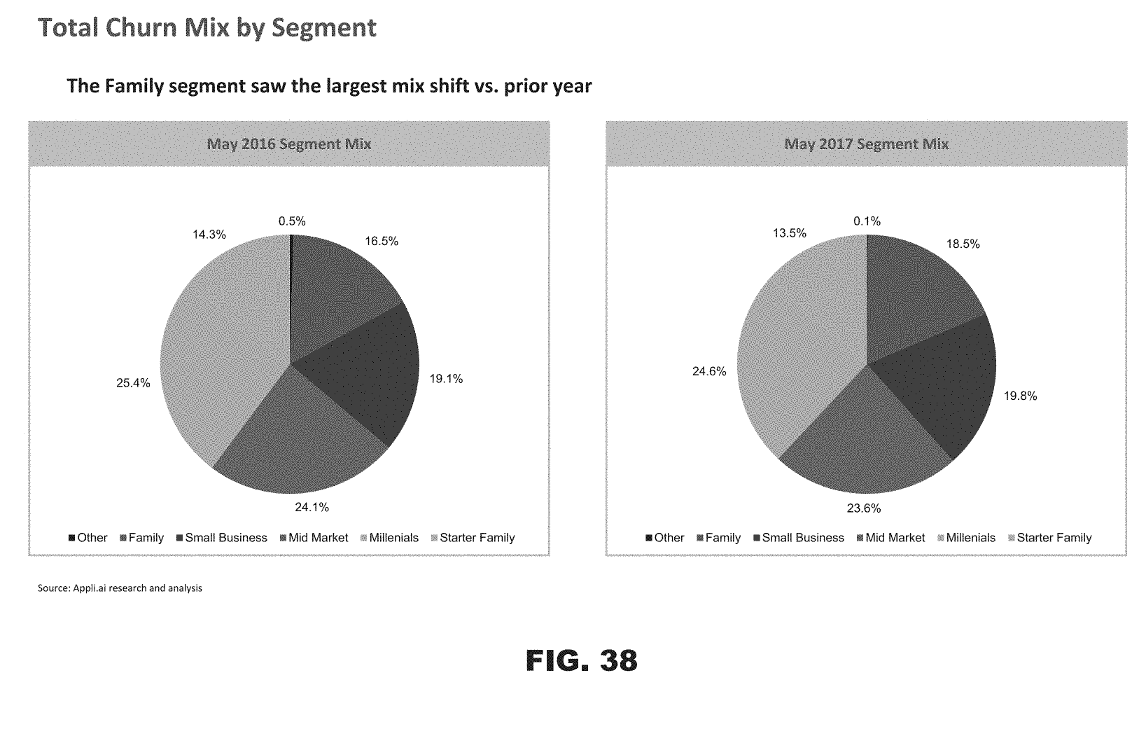

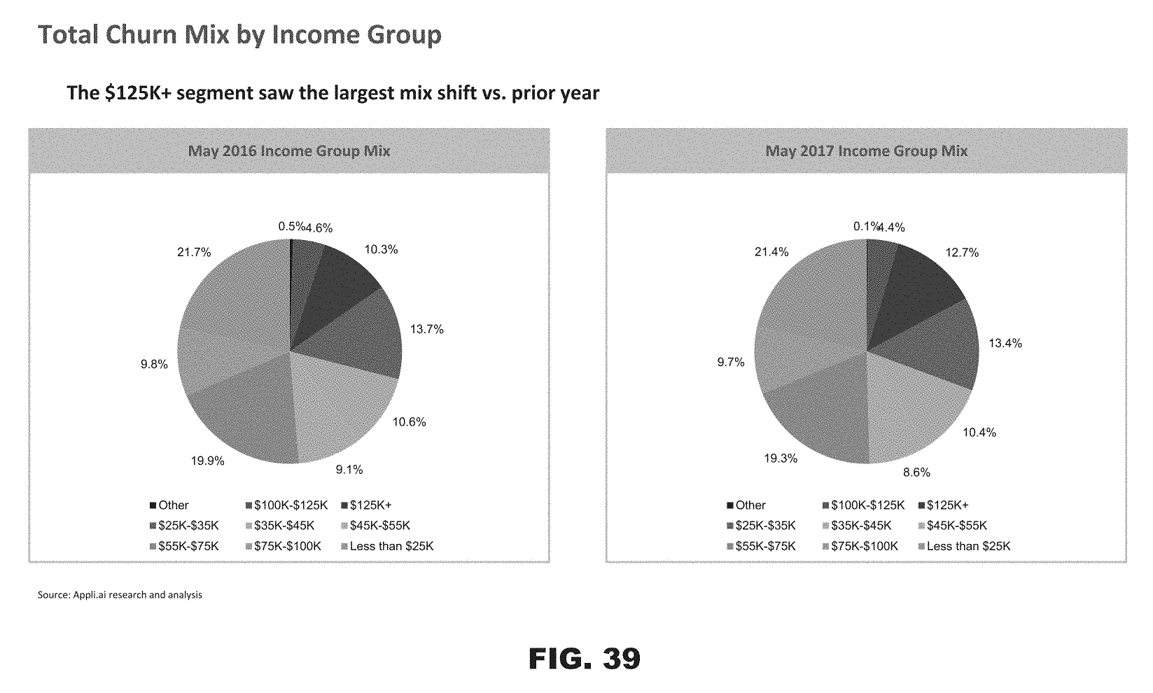

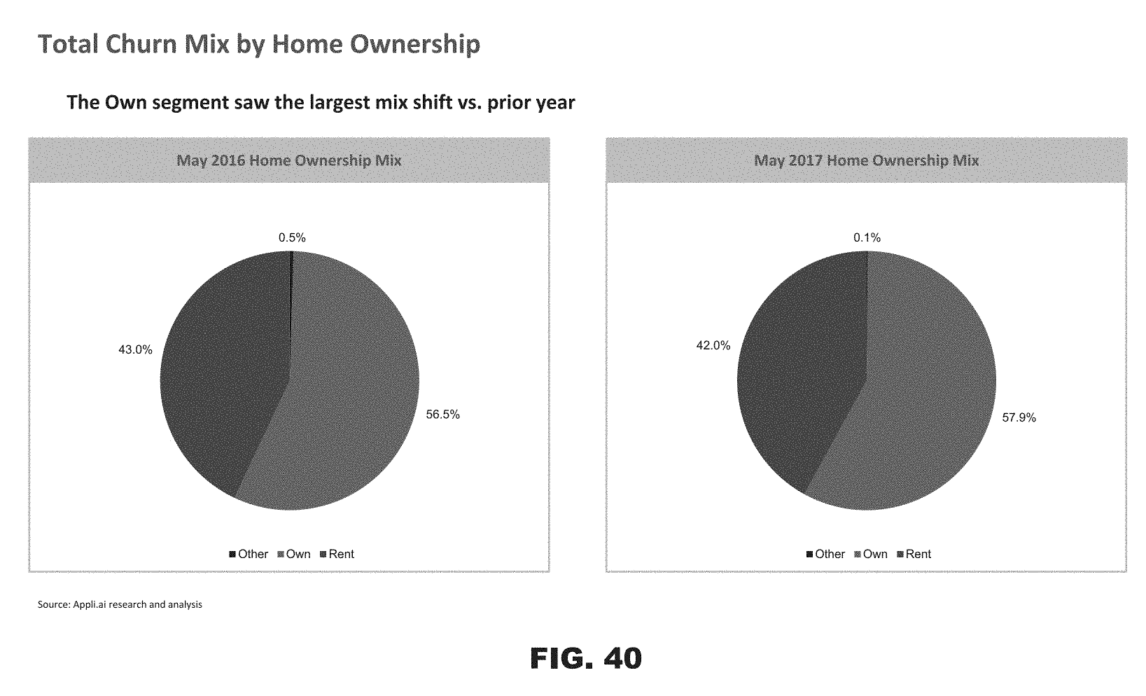

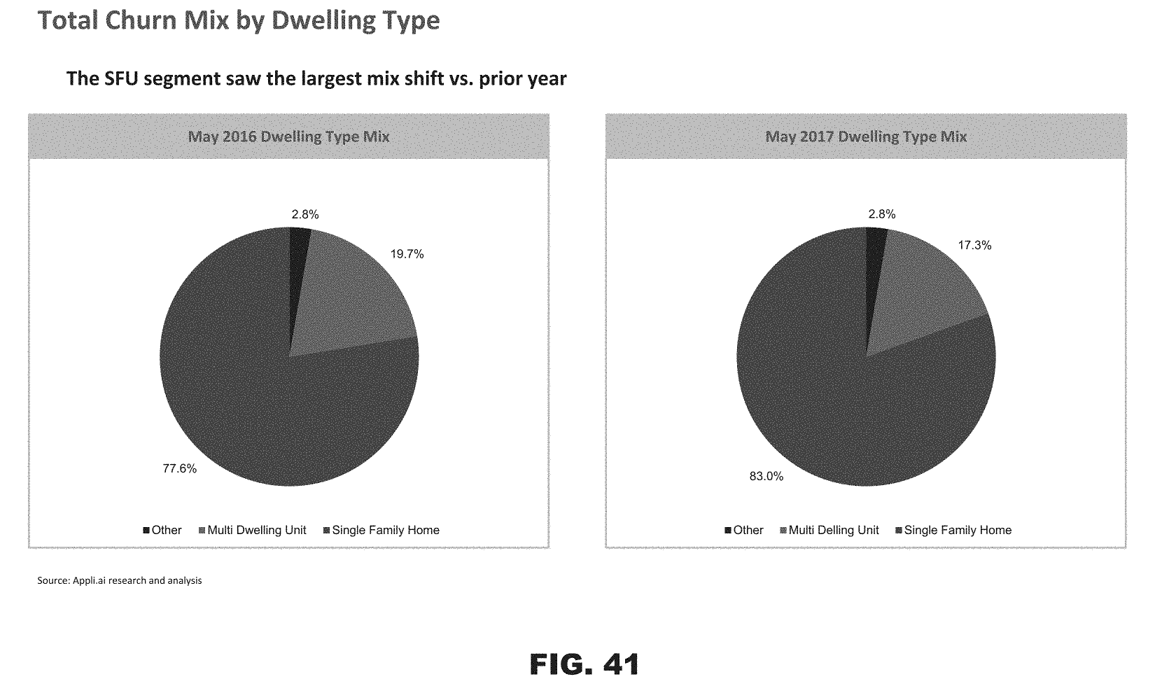

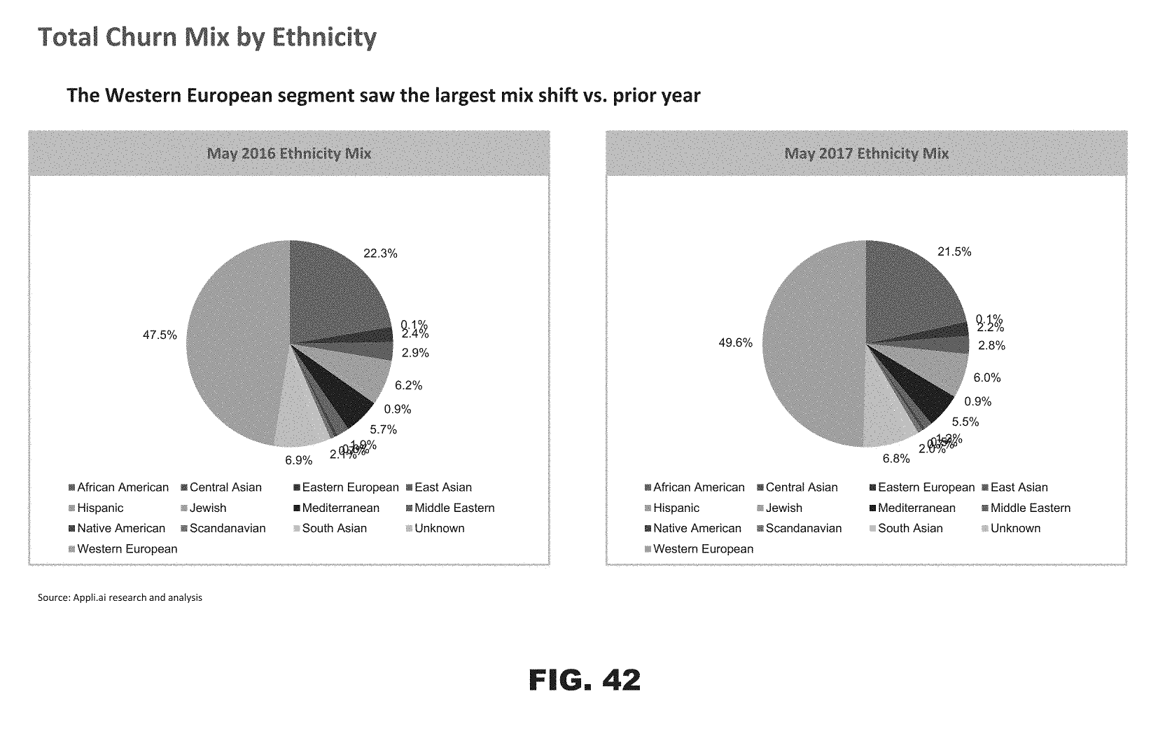

Various aspects of the systems and methods according to embodiments of the present disclosure are depicted in FIGS. 1-42. It should be understood that the drawings are not necessarily to scale, and in certain instances, details that are not necessary for an understanding of the disclosure or that render other details difficult to perceive may have been omitted. Also, certain details may be depicted in certain drawings while omitted in other drawings, but it is to be understood this is done for the purpose of streamlining the disclosure. Accordingly, components and elements shown in certain drawings may be included in other drawings or embodiments despite those components/elements not being explicitly shown in each individual drawing figure.

Components, elements and modules of the system according to embodiments of the present disclosure are shown in FIG. 1. Several elements may be grouped in a database server 10, as reflected in FIG. 1. However, it is to be expressly understood that these elements may reside on separate servers or locations, including in the absence of a traditional server. In embodiments, the system comprises source data 20, which may represent data provided by or associated with a business or organization. The source data 20 may comprise third party data, and may include structured and unstructured data. The systems and methods described herein preferably comprise a Data Transformation 30 module or step, as shown in FIG. 1. In embodiments, Data Transformation 30 is necessary and/or useful for later aggregation of data, efficient processing or data, and during the driver graph inflation process described in detail below. In certain embodiments, Data Transformation 30 is automated or semi-automated. In other embodiments, a portion of the Data Transformation 30 occurs through manual processes. Combination of these embodiments is contemplated for purposes of the present disclosure.

To further illustrate Data Transformation 30, reference is made to Table 1 below:

Table 1 displays data arranged in a dataset following Data Transformation 30. In preferred embodiments, the dataset comprises a unique identifier (uid), which may be used to trace any individual line of data within the dataset. The dataset also preferably comprises a period field, which in Table 1 represents the month and year associated with each row of data in the dataset. Multiple dimensions may also be included with the dataset, such as market1, market2, product1, product2 and segment in Table 1. As shown, certain dimensions may comprise multiple dimensional levels (i.e., market and product), while other dimensions may comprise only a single level (i.e., segment). However, any combination and number of dimensions may be included in a dataset, regardless of whether they are multi-dimensional or singular. Table 1 also depicts the individual metrics, such as revenue and sales units. Metrics are important to the Data Transformation 30 process because they represent important business or organizational values and, once mapped, may be aggregated, associated with or compared to other metrics. The systems and methods described herein also permit visually representing individual and aggregate metrics despite the typically large quantities of data obtained from the source data 20. By completing the Data Transformation 30 and formatting the datasets in this manner, individual or aggregated metrics may be queried, polled, sorted, filtered, manipulated and displayed in a meaningful manner, regardless of quantity, through the systems and methods described in detail herein.

In certain embodiments, source data 20 cannot be aggregated into a single dataset. This can occur where, for example, the source data 20 is extracted for different periods. To expand on this example, when one dataset is aggregated at a monthly frequency, and another is on a quarterly or yearly frequency, it may require the datasets to be loaded separately. Alternatively, one dataset may include a different set of dimensions than another. For example, sales data may include one or more “channel” dimensions, but inventory data does not.

The underlying data in the datasets may be aggregated at different and incompatible “grains”. For example, certain data correlating to a place of lodging may be stored at the “stay” grain such that all metrics (revenue, customer count, etc.) apply at a “per stay” grain, while another dataset, such as the general ledger, might aggregate the same data on a daily or weekly basis. In such cases, the aggregates of metrics will not match because the source periods, dimensional hierarchies and grains do not match across datasets. As a result, it is useful to allow multiple datasets to define different metrics that can co-exist in the same data graph structures.

In the example where periods differ, if one period can be mapped to another (e.g., daily to monthly periods), the dataset may be consolidated at the coarsest level (monthly) and treated as a single dataset. Conversely, if the periods cannot be matched (week-of-year vs month), then the two datasets can still be loaded across the same level of nodes while still being treated independently (i.e., each with its own set of periods and measures). These datasets may alternatively be aggregated at a longer, common time period (such as a year).

For datasets with differing dimensions, those datasets may still be made congruent so long as the dimensional values are at least partially consistent across all datasets (i.e., at least partially overlap). For example, if dataset A includes market and channel dimensions, and dataset B has market and product dimensions, those metrics may be combined within the same driver graphs (so long as the overlapping dimension has consistent values across the datasets).

When the “grains” are different, aggregation is difficult to achieve in a consistent way across the datasets. However, as long as the period and dimensions are aligned, the Data Transformation 30 may use different measures for each of the grains. In the lodging example, this could result in different measures such as stay_revenue and stay_length for stay-related “grain” data, and daily_revenue and daily_room_rev for day-related “grain” data. While these measures do not match, Data Transformation 30 may store the grain data in a common nodal level as long as the dimensions and reporting periods are consistent across the datasets.

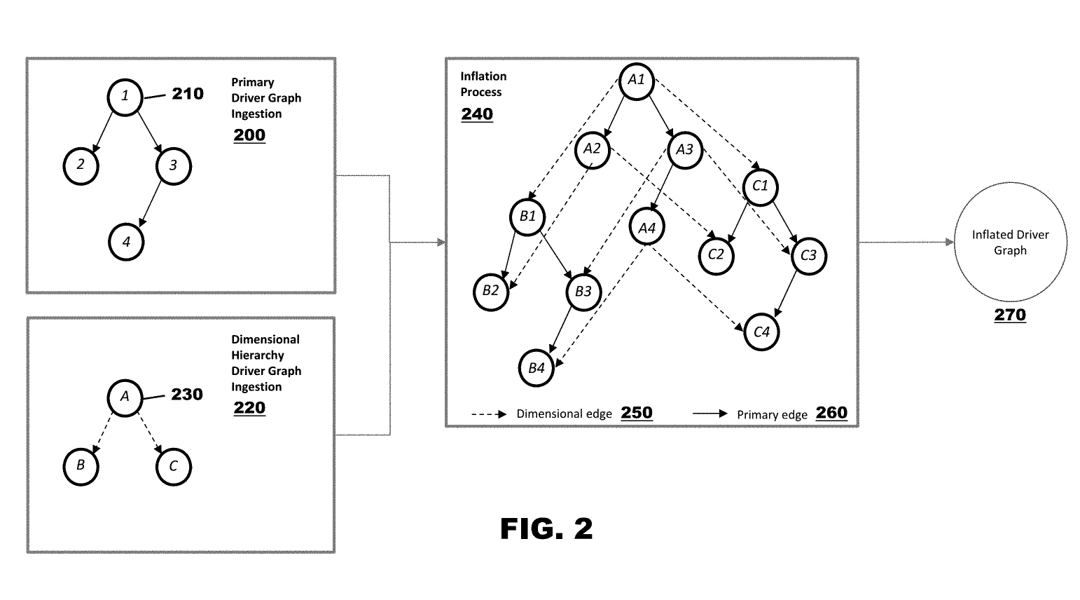

As described in more detail in relation to FIG. 2, the systems and methods further comprise a Primary Driver Graph Generation 200 module or step. According to embodiments, the Primary Driver Graph 70 refers to a set of business measures, outcomes or metrics, and their respective relationships with each other, preferably without consideration of the different dimensions of the business (including by way of example but not limitation, product(s), market(s), revenue, costs, distribution channel(s), customer segment(s), administrative unit(s), etc.) The Primary Driver Graph 70 is formulated via the Primary Driver Graph Generation 200 module, preferably incorporating metrics derived from the source data 20. Thus, according to embodiments, the Primary Driver Graph 70 is based on an organizations metrics and fundamentally defines how those metrics, which in turn capture the performance of a business or other organization, relate to each other. Once generated, the Primary Driver Graph 70 is preferably stored in a database, as shown in FIG. 1.

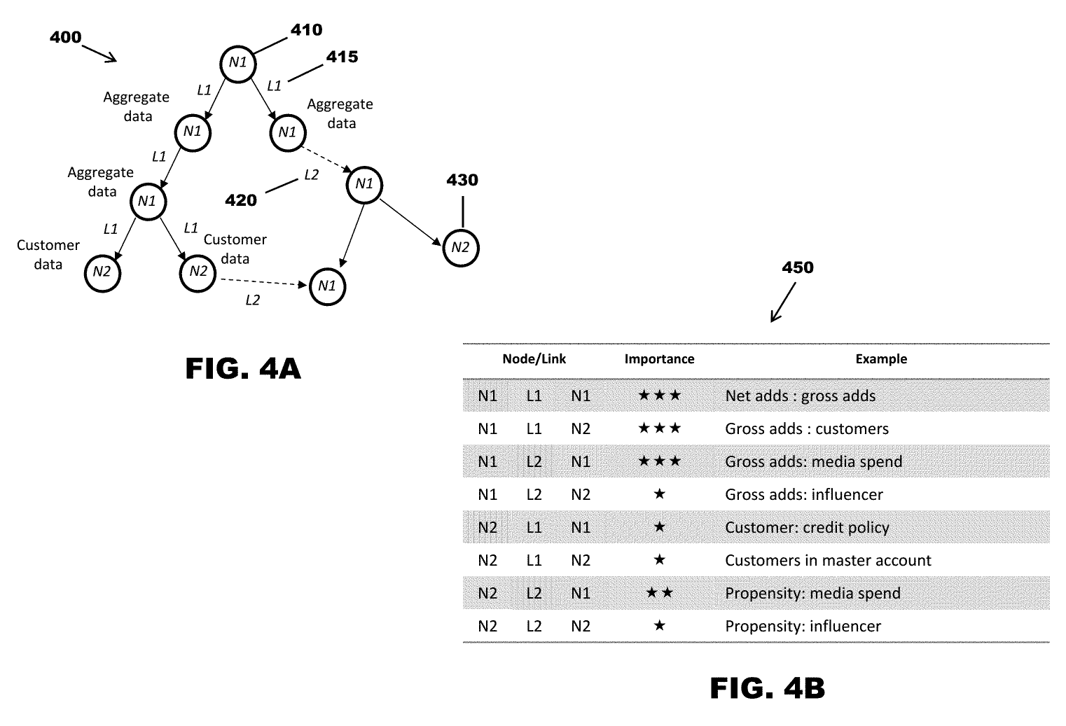

A typical Primary Driver Graph 70 may include hundreds of nodes 210, and while generating such a Primary Driver Graph 70 manually is possible, it is a long and arduous process, subject to error. According to the systems and methods described herein, the Primary Graph Generation 200 process automates (or in some embodiments, semi-automates) the generation of the Primary Driver Graph 70, in part through an unsupervised structure learning approach, that can efficiently produce a Primary Driver Graph 70 for a set of metrics. As described in greater detail below, the Primary Driver Graph Generation 200 module or step preferably identifies and assigns links among nodes in the Primary Driver Graph 70, including those that a human user would have difficulty identifying. Further illustration of this embodiment is provided in relation to FIGS. 4A-12B.

In most embodiments, the systems and methods further comprise a Dimensional Hierarchy Expansion 220 module or step, which comprises the processing of structured data received from the Source Data 20, following the Data Transformation 30, to generate a structure of “nodes” and “edges” that comports with the hierarchy of the organization's data. The Dimensional Hierarchy Expansion 200 associates metrics with nodes, at appropriate levels within the hierarchy, so that the system can efficiently aggregate those metrics across all nodes in the Primary Driver Graph 70 and, eventually, an inflated Driver Graph 80 (as described below). In the drawing figures, particularly FIGS. 2-12B, nodes are visually represented as circles on the Driver Graph 70, whereas relationships between nodes (also referred to herein as links or edges) are visually represented by lines between two or more nodes. In certain drawing figures, such as FIG. 2, solid lines between nodes represent primary links or edges, whereas dashed lines represent dimensional edges. In these figures, the dimensional edge between nodes is derived from the Dimensional Hierarchy Expansion 200 module and Primary Driver Graph 70. In yet other figures, such as FIG. 4A, the solid lines (L1) represent deterministic links, while the dashed lines represent probabilistic links.

Once compiled, the Dimensional Hierarchy 60 is stored in a Dimensional Hierarchy Database (DHDB) and comprises the hierarchical representation of the organizations various dimensions. These dimensions and associated metrics may be maintained with the DHDB in a graphical format, such as a Primary Driver Graph 70. The Primary Driver Graph 70 may be understood as a basic set of nodes and inter-nodal relationships that correlate to other nodes and nodal relationships associated with the organization, and which serve to define the metrics of the organization are attributable to primary nodes.

Referring to FIG. 2, the systems and methods described herein may also comprise a Driver Graph Inflation 240 process. The Driver Graph Inflation 240 process is necessary for most businesses and other organizations because the Primary Driver Graph 70 alone is not sufficient to generate business insights, in part because the Primary Driver Graph 70 does not possess any dimensional information for any of the metrics. Incorporating an organization's dimensional information will typically multiply the size of the Primary Driver Graph 70 by a factor of 1,000 to 10,000. Thus, while generating a Primary Driver Graph 70 is considered extremely difficult to achieve manually, the generation of a complete or inflated Driver Graph 80 is outright impossible for a human to handle. According to embodiments, the AVA described above is configured to implement the Driver Graph Inflation 240 process to augment the Primary Driver Graph 70 with dimensional information. This process is preferably highly (if not completely) automated and allows the system to generate a full driver graph necessary to produce insights.

During Driver Graph Inflation 240, the Dimensional Hierarchy 60 and Primary Driver Graph 70 may be relied upon to expand or inflate the node and nodal relationship data, and incorporate the same into other driver graphs as shown in FIG. 2. For example, by combining metrics from the Primary Driver Graph 70, and the dimensional data from the DHDB, additional primary and secondary (also referred to as parent and child) nodes may be extrapolated. Thus, primary interrelationships 260 (represented by solid arrows in FIG. 2) that have already been determined as to primary nodes A1-A4 can be inflated to nodes B1-B4 and C1-C4. Similarly, dimensional relationships 250 (represented by dashed arrows in FIG. 2) can be inflated from node A1 to B1 and B2, or A4 to B4 and C4, for example. As additional nodes 210 are identified, the AVA may assign previously determined relationships between the one or more additional nodes. The relationships may be sophisticated and evolve into dimensional hierarchies 60, which may follow established or ad hoc rules or methodologies. In some embodiments, the user may establish new rules and/or methodologies as orphan nodes are uncovered. In other embodiments, the AVA is able to recognize the different interrelationships between the one or more nodes and establish rules and/or methodologies without assistance of the user. In yet other embodiments, the user is given the opportunity to review and revise the rules and/or methodologies derived by the AVA.

During Driver Graph Inflation 240, node statistics and relationships may be evaluated and tested against the Primary Driver Graph 70 and dimensions of the DHDB. For example, once inflation has occurred along primary and dimensional lines, the system may be configured to determine node statistics such as z_score, deviation, last value, mean, etc. The system may also be configured to determine the contribution from a child node to a parent node, or their respective values and/or variances. This information in turn may be used to test or evaluate the correctness of the Driver Graph Inflation.

Referring to FIGS. 1 and 2, the inflation may result in a Fully Inflated Driver Graph 80, 270. The Fully Inflated Driver Graph 270 may be stored with the DHDB and Primary Driver Graph 70, and may be configured to communicate with an Application Server 100 via a Driver Graph API 90. The Fully Inflated Driver Graph 270 may be updated and modified as new source data 20 is received or new Dimensional Hierarchies 60 are defined. Although not shown in FIG. 1, embodiments may further comprise at least one data repository, such as a financial data repository, a sales data repository, a customer-relationship-management data repository, a business-specific data repository, and a remotely connected third-party data repository. The data repository may also store a set of user preferences and one or more sets of user data.

In embodiments, the system may comprise one or more applications 110, which may be in communication with AVA through one or several modules. In one embodiment, the application 110 is designed to operate on a mobile device or mobile computer and assist a user with managing data and providing organization among the AVA. In one embodiment, the application/modules 110, 120, 130, 140, 150 are configured to access one or more datasets, tables or databases, including one or more relational databases. In one embodiment, the application 110 includes time and/or content-specific notifications. In embodiments, the application/modules 110, 120, 130, 140, 150 further permit a user to sort, search and modify documents and manipulate data associated therewith, in many instances automatically.

Referring again to FIG. 1, the Application Server 100 comprises computational machinery and/or computer-readable media specially configured for performing various aspects of the systems and methods described herein. The Application Server 100 preferably comprises the main application and associated API 110. In one embodiment, the main application and API 110 is derived from a web application framework, such as Django. The main application 110 is preferably in direct communication with the Driver Graph 80 and Dimensional Hierarchy Database, via the Driver Graph API 90, to read, write and process driver-related information and application data. The application 110 is also preferably configured to communicate with other modules, including but not limited to an Administrative Module 120, an Authentication Module 130, a User Group Module 140 and a Notification Module 150. The application 110 is also in communication with the Analytics Engine 160 described in greater detail below.

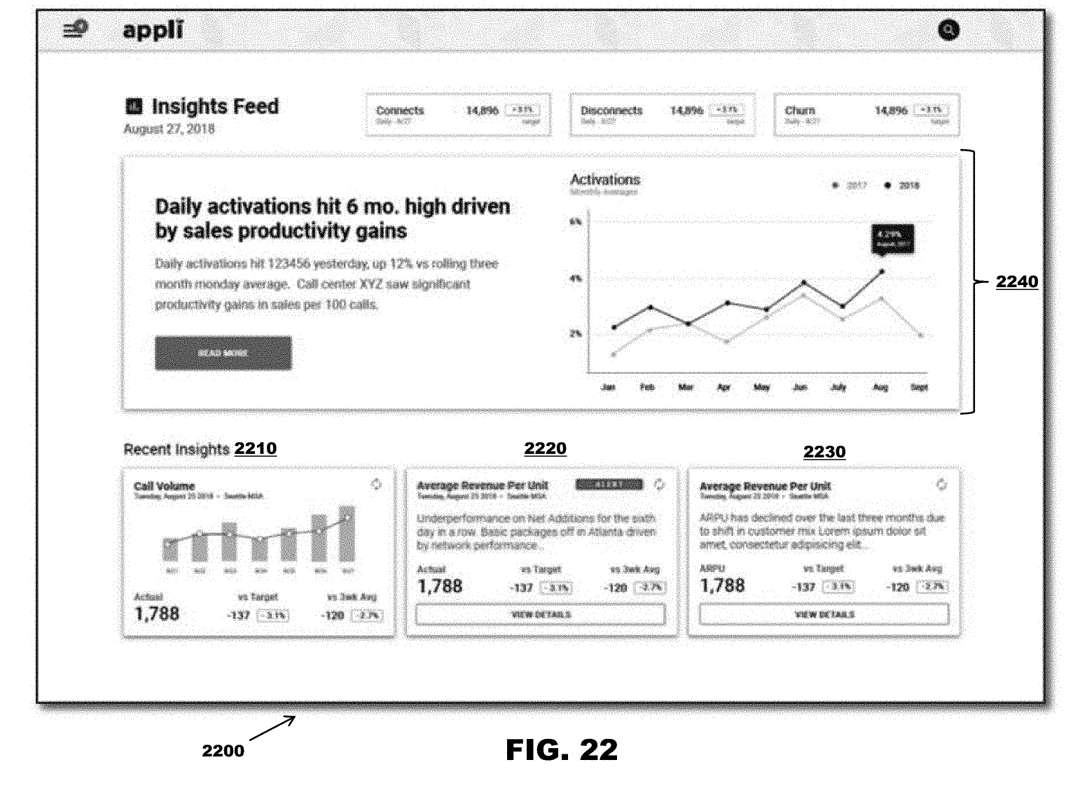

The Application Server 100 may also be in communication with a Web Server 115 as shown in FIG. 1. The Web Server 115 preferably comprises a Gateway 105 and HTML Server 108, which in turn communicates and conveys information from the Application Server 100 to the Display Server 125. The Display Server 125 may comprise a processor 129, network adapter 127, web browser 133 and other elements that will be readily understood by one of ordinary skill in the art. The Display Server 125 also preferably comprises the Display Application 137 and associated Report Generator 141, Data Explorer 139, Driver Graph Visualization 145 module and other modules 143 described herein (in particular, FIGS. 22-27).

Returning to the description of the Primary and Fully Inflated Driver Graph 270, in certain embodiments the AVA may adapt the graph and/or mapping autonomously, thereby transforming the Driver Graph 70 into a predictive and proactive tool for an enterprise. For example, using the adaptive learning and other capabilities described herein, the AVA may develop the ability to predict where root causes of enterprise performance issues originate, and potentially alert the user before the issue elevates to a potential anomaly or anomaly. In other embodiments, the AVA may evolve a module to improve upon the model or map of the enterprise and make suggestions to the user of ways in which the nodes can be redefined, and thereby adapt its analytical and forecasting capabilities in a non-stationary environment. For instance, if the AVA identifies a change in the enterprise environment, such as a change in the database environment, a change in market structure, in product hierarchy, or in competitive dynamics (for example), the AVA will adapt to reallocate connections and/or resources to continue functioning optimally in the new environment in spite of said changes. However, in lieu of or in addition to the remediation features of the AVA, the module may further suggest a remodeling of the node cluster and the underlying operating resources to alleviate the operating impact and related issues of the changes in the enterprise environment. Thus, an enterprise may learn new ways of structuring its various nodes and removing unhealthy interdependencies through use of the AVA and Primary Driver Graph 70 module.

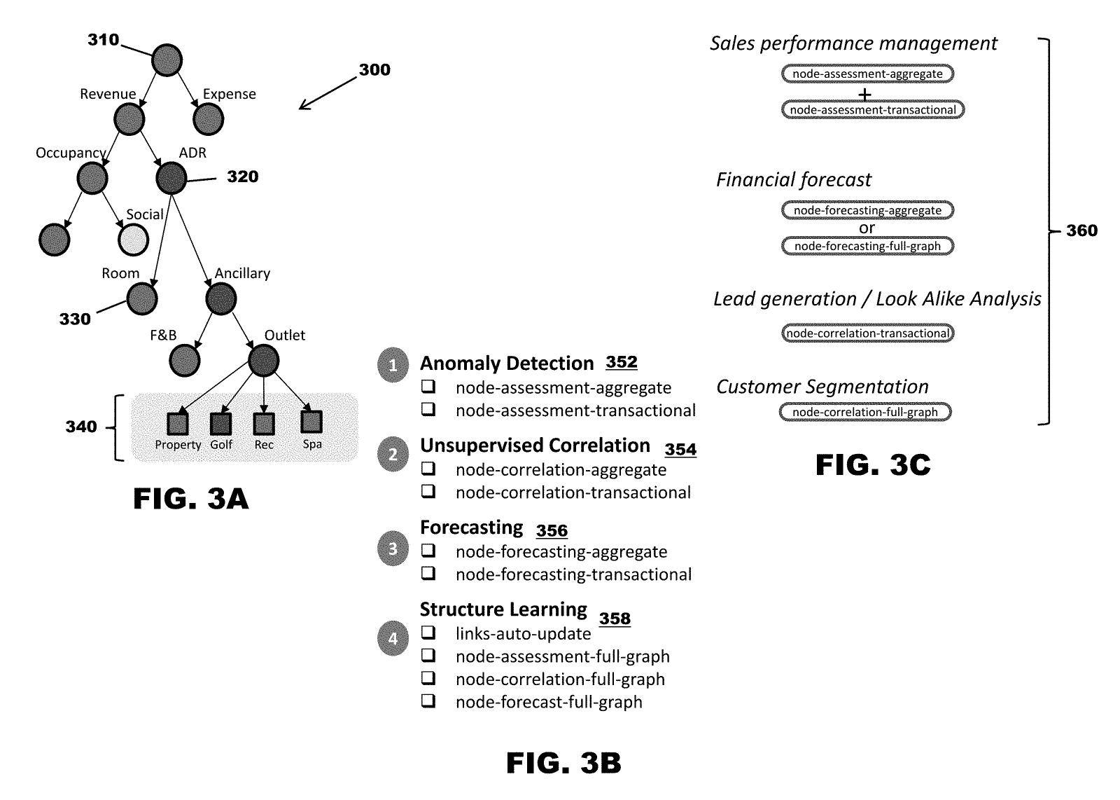

Additional aspects relating to the Driver Graph 70 and various nodal relationships disclosed herein are shown in connection with FIGS. 3A-12B. For many organizations, the number of discrete “nodes” is so large that it is difficult, if not impossible, to graphically present those nodes in a logical manner. Even when focusing on specific business applications, a graph or equivalent display often includes anywhere from a dozen to hundreds of thousands of nodes. Manually creating and maintaining such a graph is impossible, particularly when the nodes in the graph require periodic modification or have dynamic relationships with other nodes that need to be assessed and, in many cases, reevaluated.

Referring specifically to FIG. 3A, nodes 310, 320, 330 are preferably displayed showing their connections (i.e., relationships) to other nodes in the system. In some instances, multiple nodes may be connected to the same node. Certain nodes may appear in the interface to represent a parent-child relationship, whereas other nodes may be more appropriately classified as peers. In some embodiments, a parent node 310 may be graphically represented in a manner differently than a child node 330, such as by appearing larger than the affiliated child node. In this same embodiment, peer nodes may be sized or shaped or colored the same to indicate those nodes are peers. Variations on the embodiments described and depicted in this disclosure are contemplated.

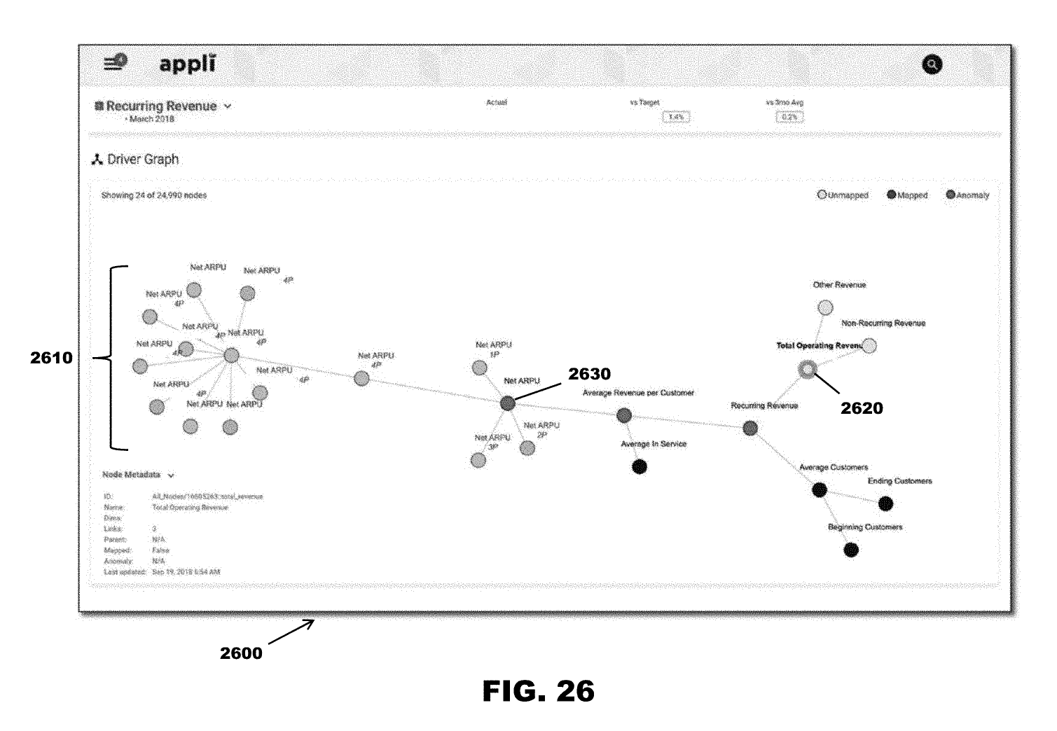

The visual representation associated with the driver graph 300, such as the one shown in FIG. 3A (also shown in FIG. 26), further enhance the user's ability to understand anomalies in the data set associated with the driver graph 300. For example, when a metric and its associated node in the driver graph 300 is found to be anomalous, an associated display provides a visual clue or indicia to call the anomaly to the attention of the user. As yet another example, the display may further provide a summary of automatically generated insights derived from the anomalies detected. These aspects of the system are elaborated on in more detail below.

Referring now to FIG. 3B, once the Fully Inflated Driver Graph has been stored, the system may comprise numerous analytics to a user. These analytics may comprise Anomaly Detection 352, for example through node assessment (in the aggregate or on a transactional scale). Other analytics may consist of Forecasting 356, Structure Learning 358 and Unsupervised Correlation 354. Each of these is described in greater detail below. Business and/or organizational application of these various analytical tasks 360 are represented in FIG. 3C.

To better illustrate the aforementioned analytics, it is important to note that each Driver Graph is preferably configured to be responsive to system anomalies and other events to provide dynamic insights to a user. Once the system detects anomalies with the performance or state of specific nodes, the Driver Graph is configured to determine the root cause of such anomalies to generate a useful business insight. Anomaly Path Generation and Detection or AGPD, as referred to herein, is a heuristic approach applied to all node anomalies. It is equivalent to a triage process for identifying potential and/or likely root causes. Root cause analysis inherently raises the question of what a root cause is. While the notion of proximate cause is easily defined, that of ultimate (or root) cause is much more elusive. APGD handles this problem of root cause identification efficiently by determining and evaluating a weighted score for detected anomalies and, in certain embodiments, their distance (in the graph) from the metric or node being assessed.

While APGD is efficient and practical in handling a large volume of data, it may not be optimal due to its heuristic nature. Root Cause Focusing (RCF) provides a more optimally defined solution to the problem of root cause identification by looking at anomaly causes at various distances from the node of interest. In preferred embodiments, RCF builds a series of Pareto curves and identifies the curve or layer that provides the most contrast or the best-defined feature explaining the anomaly at the node of interest.

At this stage it is also worth noting that the system may be configured to establish a hierarchy between classifications of business or financial information and thereby perform more sophisticated pattern and comparative analysis. In embodiments, the system may be configured to interpret the DHDB and establish one or more new hierarchies based upon the information in the database. The system and method may further comprise a machine learning module for adapting to new data and making conclusions regarding the classification or hierarchies to which the new data belongs. In other embodiments, the system and method may comprise a training module for user-driven learning of the differences between different data sets and associations that may be drawn by the AVA for analyzing the same.

FIGS. 4A-4B illustrate a taxonomy for the driver graph 400 and various node-link relationships in greater detail. In FIG. 4A, a Driver Graph 400 is shown comprising various types of node/link relationships 415, 420, wherein node N1 410 consists of aggregate level data and node N2 430 consists of customer-level data. The node/link relationships 450 are further illustrated in FIG. 4B. For example, the N1-L1-N1 node/link relationship comprises a net adds to gross adds relationship, whereas the N1-L1-N2 node/link relationship comprises a gross adds to customers relationship. As shown in FIG. 4B, certain node/link relationships 450 may be scored or weighted with greater importance to an organization than others.

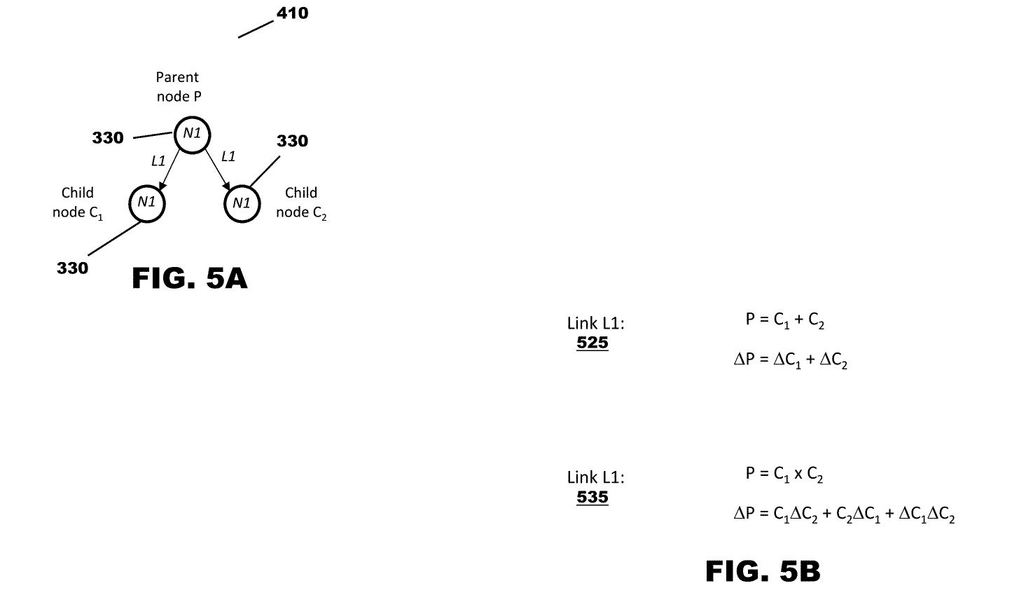

Referring to FIG. 5A, one particular taxonomy of a parent/child nodal relationship is shown. Here, one of the simplest relationships is shown by a parent node P 510 and two child nodes C1 520 and C2 530. These nodes are linked according to the N1-L1-N1 archetype described above in relation to FIG. 4A, which applies to many key performance indicators in a given organization. Turning to FIG. 5B, the relationship or link 525 between P1, C1 and C2 may be defined by the equation P=C1+C2. An example of this type of relationship, in a business context, would be net adds to gross adds. Alternatively, the relationship or link 535 may be defined as P=C1×C2. The logical relationship between nodes, including for a simple type such as the one shown in FIG. 5A, may be defined in a number of ways. In embodiments, these relationships are derived in part from the DHDB and the primary driver graph, as well as related processes described above.

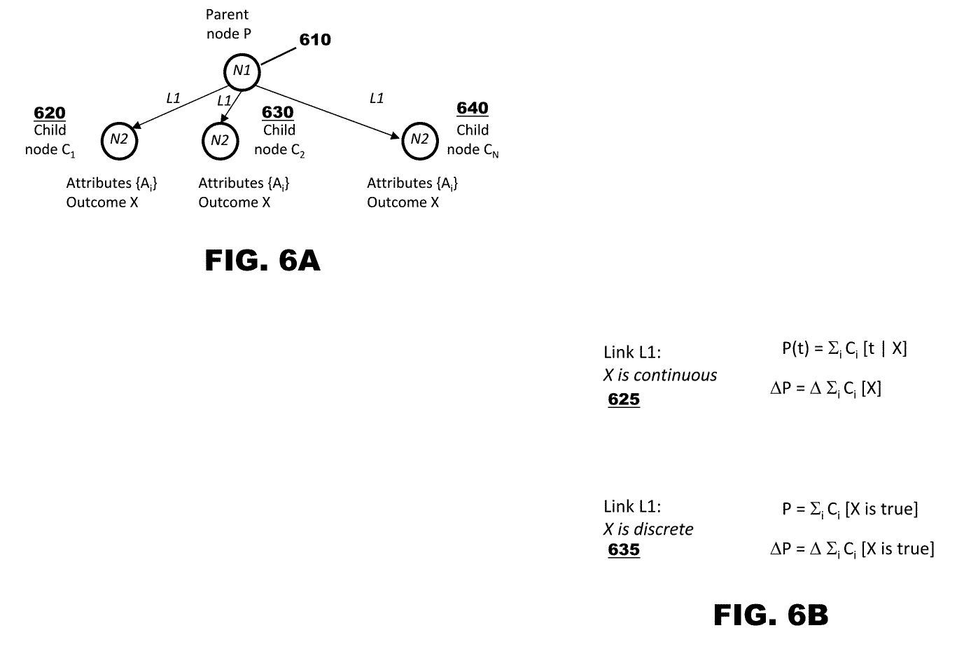

FIG. 6A-12B depict other taxonomies and associated node-link relationships used with the systems and methods described herein. In FIG. 6A, a N1-L1-N2 archetype has been added to the driver graph, which may be used to bridge from an aggregate node/link relationship to a transactional one. This in turn permits a user to parse key performance indicators by individual customer attributes. The corresponding logical relationships 625, 635 between the nodes 610, 620, 630, 640 shown in FIG. 6A are listed in FIG. 6B. These logical relationships may apply to outcomes on a continuous or discrete basis, and may be filtered in terms of specific customer attributes.

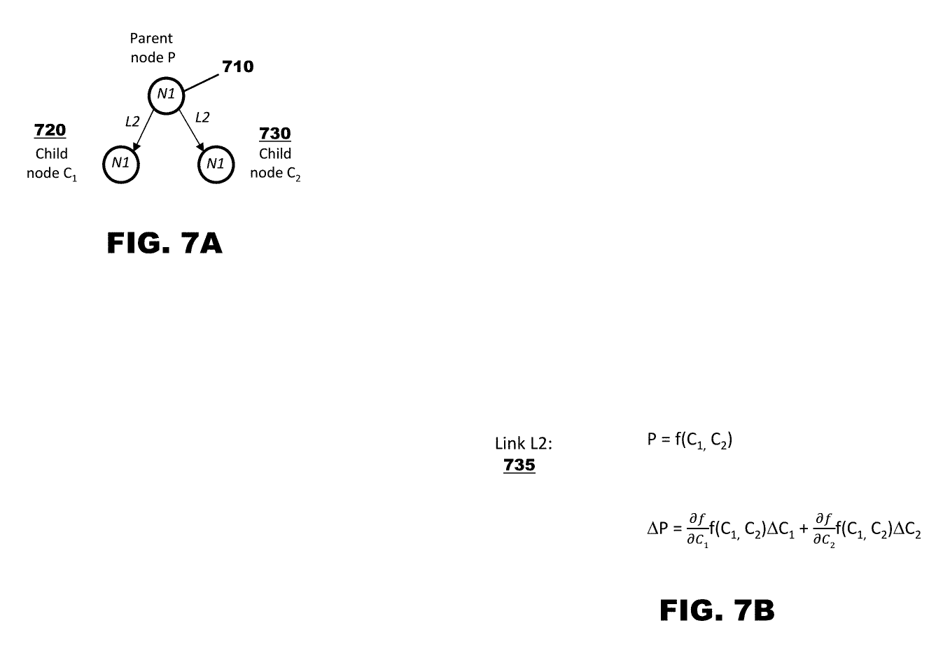

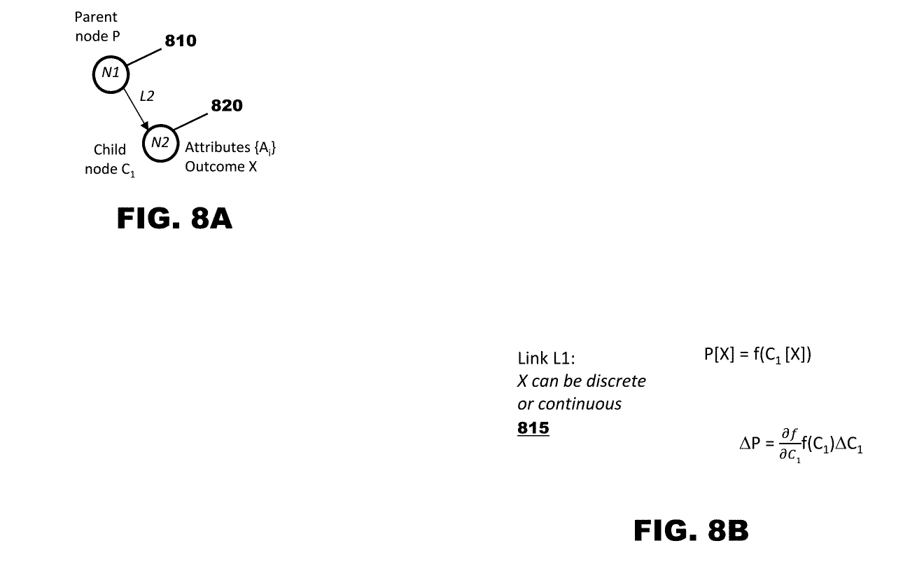

Referring now to FIG. 7A, the N1-L2-N1 archetype is shown by a three-node driver graph. This relationship may be applied, for example, when linking a management key performance indicator to an operating key performance indicator. Unlike previous relationships, which are largely or solely deterministic, this node/link archetype introduces a probabilistic factor. Thus, in reference to FIG. 7B, the logical relationship 725 may be defined in part by a function ƒ derived through Bayesian analysis, regression analysis, or some other form of analysis. Variations on these node/link archetypes and their corresponding logical relationships are depicted in FIGS. 8A-12B. These archetypes and driver graph topologies establish the traversal logic applied to the graph. Accordingly, the AVA may rely upon these (and other) topologies and archetypes to determine the logic applied across the driver graph.

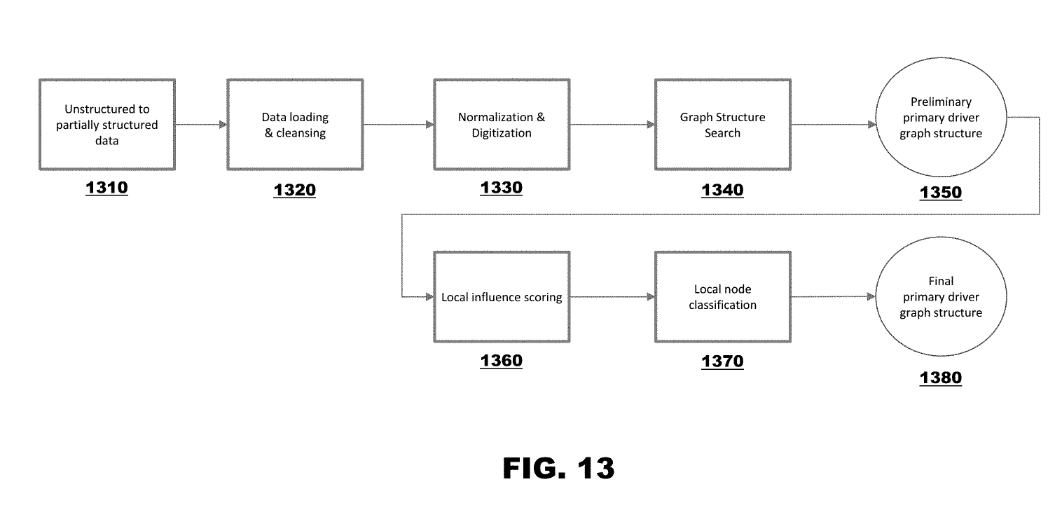

Referring now to FIGS. 13-15, various methods are depicted. In one aspect of the disclosure, the user is provided with a system according to any one of the embodiments described herein. The system may include one or more processors, memory, one or more AVAs, one or more driver graphs, and other components of the system described below. The method of using the system in this manner comprises several steps, which (regardless of sequence) permit the user to request and receive information and analysis from the one or more AVAs and otherwise obtain the benefits of the systems described above. Although financial analysis is used when describing an exemplary method, it should be expressly understood that other applications and information or data repositories, as well as other types of users, may employ the methods described herein.

In embodiments disclosed herein, the system may be further configured to automatically trigger a method associated with an AVA. In embodiments, one or more hardware and software components may be involved, including one or more of the hardware components described herein, to perform one or more of the steps of this method. The method may be executed as a set of computer-executable instructions executed by a computer system and encoded or stored on a computer-readable medium.

According to one embodiment, the method may be represented as a series of steps. According to this embodiment, the method preferably begins with an initialization step. Next, the system may determine whether user input has been received by the AVA and, if yes, subsequent method steps may be performed. For example, if the system is configured to perform any recurring tasks upon receiving a user inquiry, instruction or command, one next step may be to run and update any recurring tasks. This step may also entail scanning for new events and modifying the tasks accordingly if new events are found. Another next step may be to parse the user input using the native language processing engine, or equivalent, configured for use with the system. Once the input has been parsed, the next step may be to identify any instruction or command supplied by the user in the user input. Once identified, the system may send the assigned task to one or more AVAs, and then update the registry.

After all steps have been performed by the system and the AVA has obtained all the necessary input from the user and processed the user's request, the final step may be notifying the user and/or providing an assessment. In certain embodiments, the assessment may comprise a report or an alert as described above. In other embodiments, the assessment may be in a predetermined format for use with one or more business intelligence systems or other systems. Variations on the number and sequence of steps are contemplated.

Referring in detail to FIG. 13, method steps for generating a Primary Driver Graph are shown. The steps comprise converting unstructured to partially structured data 1310, data loading and cleansing 1320, normalization and/or digitization 1330, driver graph structure search and evaluation 1340, preliminary driver graph structure selection 1350, local influence scoring 1360, local node classification 1370, and final Primary Driver Graph structure selection 1380. It is to be expressly understood that these steps may deviate from the order shown in FIG. 13, and may comprise more or fewer steps depending on the circumstances.

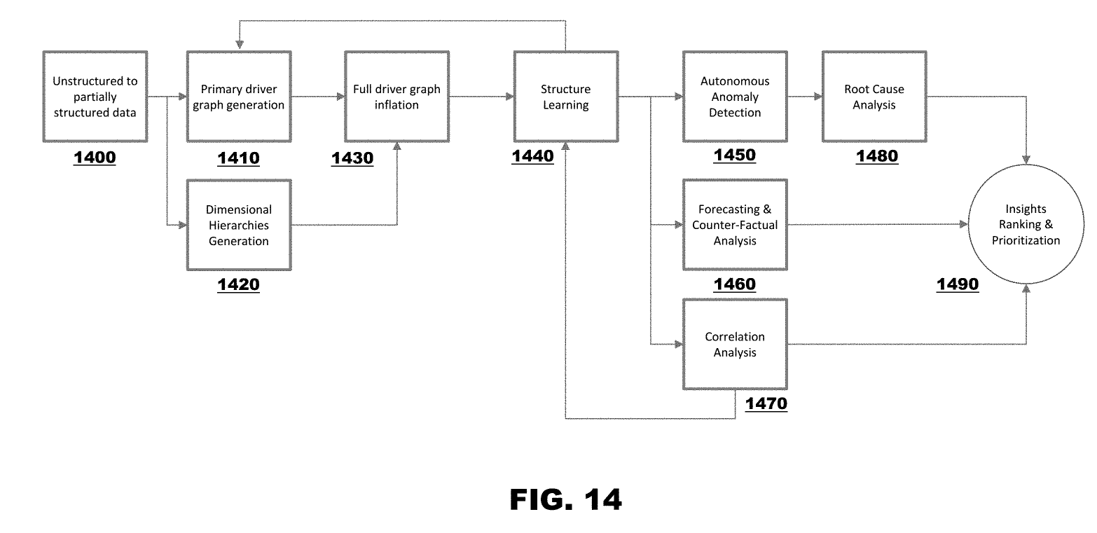

Referring to FIG. 14, a flow chart diagram is shown with various steps 1400-1490 for conducting analytics on the systems described above. Here, the analytics specifically include correlation analysis 1470, which may inform structure learning 1440 of the one or more AVA. The additional structure learning 1440 can in turn inform the Primary Driver Graph generation 1410. Thus, the analytical methods should be understood as flowing in a continuous loop for improving the Primary and Fully Inflated Driver Graph processes described herein.

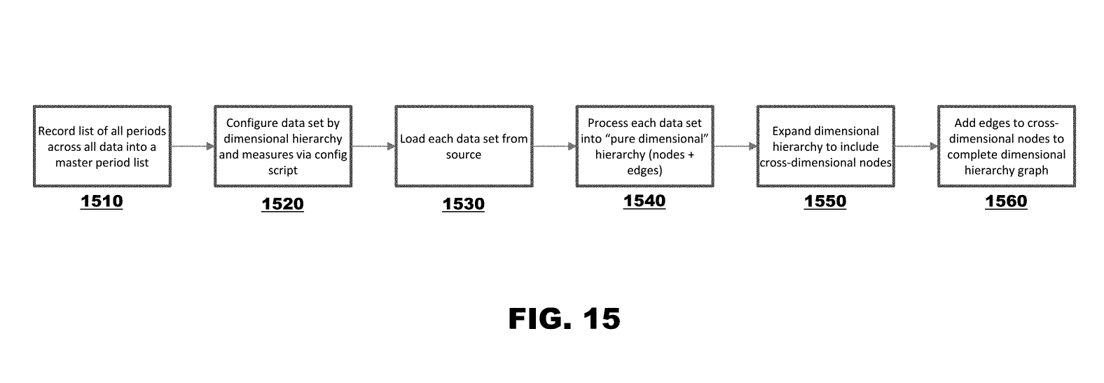

Referring to FIG. 15, a method for generating dimensional hierarchies is shown. Initially, the system may record all periods persisting in the data obtained from the Data Source in a master period list 1510. This permits the system to create a global reference identification for each period, which may be used across data sets and nodes. Next, datasets are configured by dimensional hierarchy 1520. In this step, datasets may be configured by recursively specifying a parent node, the associated dimension, plus any associated child nodes. In one embodiment, the top-level or “root” node is selected as the parent for each dimensional hierarchy. The number of levels of each dimensional hierarchy may also be established (i.e., multi-dimensionality). Each dataset preferably includes a list of measures that correspond to the mapped nodes in the Primary Driver Graph.

Once this step is completed, the data from each dataset is loaded into the system 1530. This may be achieved, in one embodiment, through a SQL command to read and extract the data from one or more relational databases. Then the datasets may be processed and assigned the dimensional hierarchy 1540 across all nodes and links (or “edges” as referred to in FIG. 2). Unique values for each dimension are assigned and corresponding nodes created. The edges are labeled according to the dimension assigned. Once an entire dimension has been processed and no more levels remain, the process continues to the next dimension until no more dimensions remain.

Next, the dimensional hierarchy created in the previous step is expanded 1550 to include cross-dimensional nodes. In this step, cross-dimensional nodes are processed to provide the same efficiencies as with parent-child nodal relationships. In this step, the system may first enumerate all combinations for each specific dimension and list all potential values (preferably including zero to represent a null dataset). Then, all cross-dimensional combinations are created. The combinations may be reduced by observing any combinations that do not have any data associated with them.

Once the cross-dimensional hierarchies are established, the next step is to add cross-dimensional links or edges 1560. Each cross-dimensional node will likely have a dimensional count equal to the number of dimensions used to create it. Thus, for cross-dimensional count n, there should be a corresponding n number of parents. The system may therefore search for each parent of a cross-dimensional node by removing one dimension from the list created in the previous step, and thereby locate the parent node that matches the removed dimension. Next, the removed dimension becomes the edge label for that cross-dimensional hierarchy.

Any of the foregoing methods may also comprise the step of performing quality assessments on the system and the AVAs to determine if the input has been properly received, the process appropriately made and the output delivered in a timely and efficient manner. This step may further comprise sending information to the user regarding any ambiguities, unresolved problems or unparsed requests that the system receives, and may also entail messaging and/or alerts to one or more users.

In embodiments, the method also comprises a step of modifying the display of records to reflect that a request has been taken or is in process. In other embodiments, the display may also change as the progress or lack of progress is made with respect to the inquiry, instruction or command.

The methods described above may continuously flow in a loop, flow according to a timed event or sequence, or flow according to a change in status. The method may be initiated or suspended by a user at various times during the method described above. Changes in status or actions taken by the user or a AVA may result in a step of changing indicia associated with the record(s) and viewable on the user interface, and may further results in the step of generating an updated message to the users involved in the request.

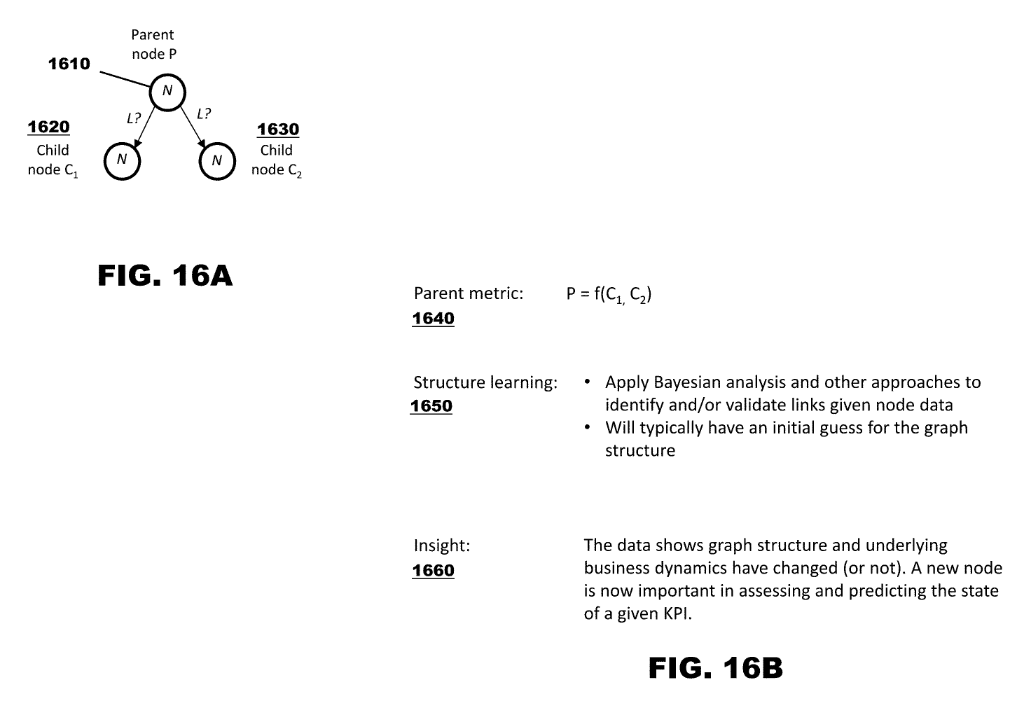

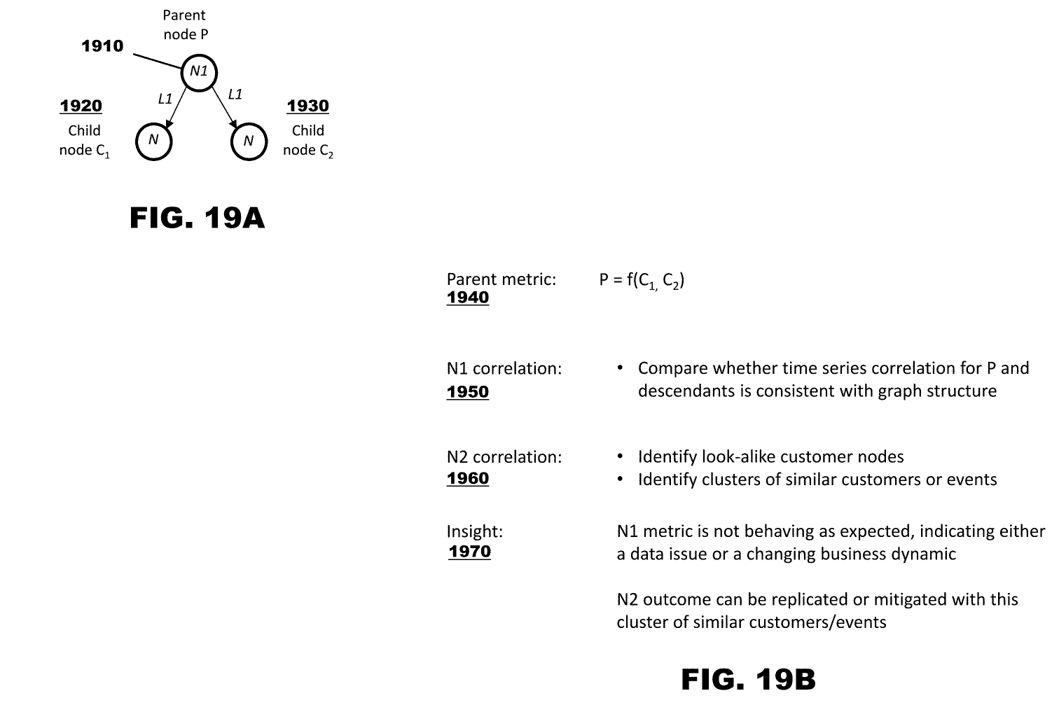

Referring now to FIGS. 16A-19B, the analytic of structure learning will be described. Structure learning is provided to better identify the structure of the driver graph in view of the various node types present in the system. Structure learning may be performed autonomously and continuously, thereby tuning and retuning the driver graph structure for a particular organization. For the driver graph shown in FIG. 19A, the structure learning may comprise applying Bayesian analysis to identify and/or validate links between nodes in light of the node data. The structure learning module may also provide a suggestion for an initial structure and then test that suggestion against other structures. Alternatively, the structure learning module may perform analysis with respect to new or changed data, which could lead to the creation of a new node. Structure learning may also evaluate and make suggestions with respect to the links between two or more nodes in a driver graph, and may test an initial link against other relational links known to the system.

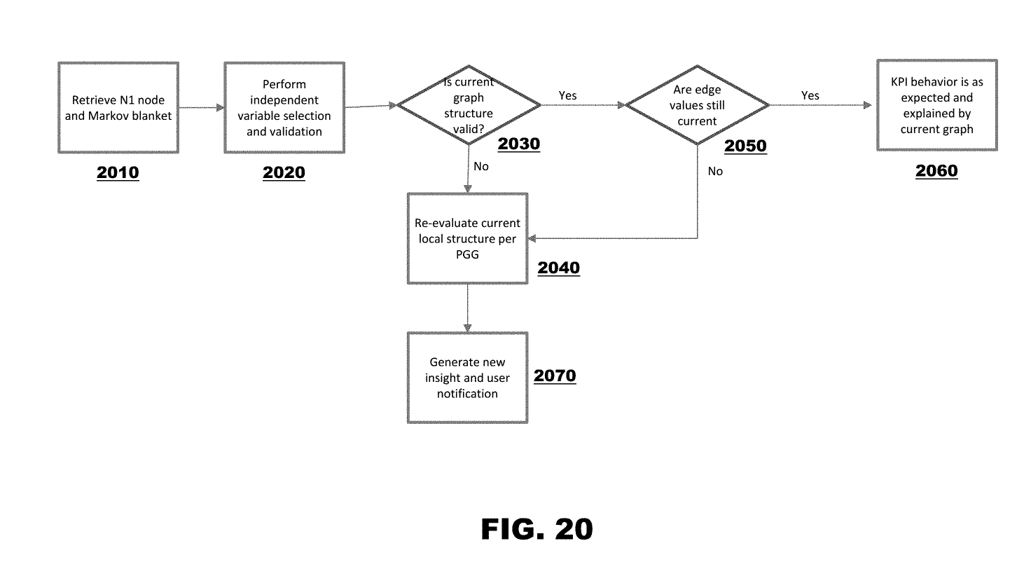

Another aspect of structure learning according to embodiments of the present system and method is depicted in FIG. 20. This flow chart shows how structure learning may be applied when periodically reevaluating the driver graph structure. In embodiments, the system includes the ability to detect changes in graph structure, including qualitative and quantitative. According to this embodiment, structure learning may include the step of assigning an independent variable 2020 and validating 2060 one or more driver graphs, whereby the systems tests if the graph structure is still valid 2030. If not, the system will reevaluate the local structure 2040 and compare that structure to the Primary Driver Graph. This method also has the ability to test links and edges between nodes 2050 and determine if current behavior and changes to nodes is expected and explained by the current graph. If any nodes or edges are found invalid, the driver graph may be autonomously updated 2070 until the graph is fully verified. Alternatively, a user may be alerted of the invalid node(s) or edge(s) and take appropriate action.

Another tool is known as correlation, and may be performed independent of the other analytical tools described herein. For example, certain business or organizational users may desire to make correlations between certain nodes at a transactional level. The system is preferably configured to permit these users to engage in unsupervised segmentation and clustering of like node data (i.e., customers and transactions). The correlation tool thereby allows a user to identify future behavior and/or business risks based on past behavior and realized risks of similar customers and transactions. Correlation, applied to the systems and methods described herein, enables propensity modeling, which is the ability to predict the likelihood of a specific customer or transaction outcome. Table 2 below illustrates a dataset comprising transformed data for use in propensity modeling:

Table 2 shows the first three rows of a transformed dataset. This particular dataset includes three dimensions: market, segment and channel, which are organized into hierarchies of different depths. The dataset has been transformed to include metrics that have been prepared to help quickly evaluate the “propensity to own” and “propensity to buy” for prod_A. In this dataset, customer_count has been defined as the number of unique customers in this group (combination of dimensions), owns_prod_A has been defined as the number of unique customers in this group that own prod_A, purchased_prod_A_in_period has been defined as the number of customers that purchased prod_A during this period, and ave_price_prod_A has been defined as the average price paid in this period for prod_A by this group.

When this transformed dataset is ingested into the DHDB, it can provide valuable information to a business on how to improve sales and optimize marketing effectiveness. For instance, as all combinations for dimensions are automatically generated and populated with the above metrics, the system may also define derived aggregate metrics such as:

propensity_to_buy_A=purchased_prod_A_in_period/customer_count, or

prod_A_sales=purchased_prod_A_in_period*ave_price_prod_A

to understand how this particular product is selling across all dimension combinations and who is purchasing it. This knowledge can be used to drive targeting efforts and optimize marketing spend across markets, segments, and channels. Correlation may be coupled with the anomaly detection functions described above to spot trends, or to alert the user of upward and downward trends that are difficult to spot with traditional tools. Thus, by transforming the metrics to include specific product purchases, the system may determine which groups of customers are likely to purchase a product. Alternatively, the metrics may be transformed to include service discontinuation or churn, thereby allowing a user to quickly view which groups of customers are likely to churn from a service.

While the analytics described herein are preferably contained within the system, it is expressly understood that these analytics may occur by a user in an unsupervised or largely unsupervised basis. By supplying the Primary Driver Graph and DHDB to facilitate the automated generation and handling of a large, fully populated driver graph, the user is free to automate and streamline any one or several of the analytical tools described herein. The user may take advantage of additional machine learning techniques, including random forest and LASSO, to perform advanced propensity modeling, such as predicting which of several outcomes is most likely at an individual prospect, customer, or other transactional level.

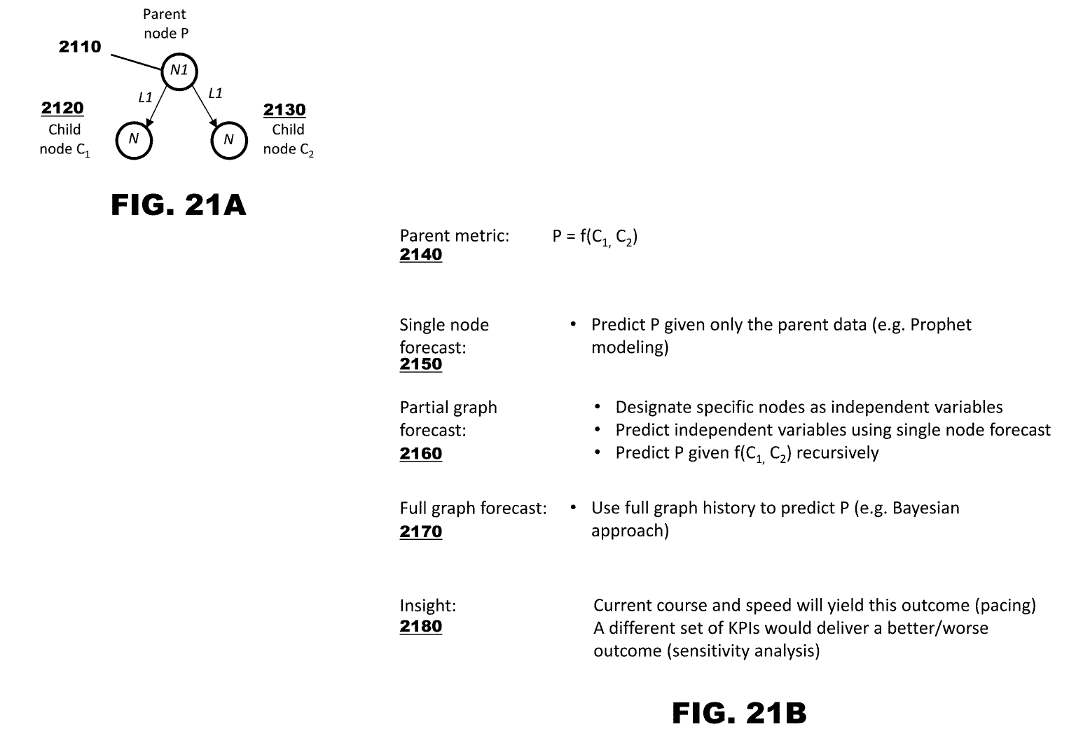

Referring to FIGS. 21A-B, another analytical tool is referred to as Forecast. In this embodiment, the system may be configured to quantify likely outcomes in the future, in part by considering the full underlying dynamics tying together the metrics of the business (i.e. using the complete model provided by the driver graph and DHDB), and the potential actions taken by the business. These variables permit a user to anticipate the most likely causal outcomes of a broad variety of potential actions being contemplated.

In embodiments, the structure of the organization's driver graph, which includes the context of the data being provided, represents a set of relationships and business dynamics that will be maintained through a forecast period. This in turn enables a user to be more accurate with their forecasting measures, in part by ensuring self-consistency of the underlying metrics. Unlike other machine learning, the present system maintains visibility into which real-world actions and drivers cause the forecast to turn out a certain way. This visibility allows a user to conduct “counterfactual” analysis (i.e., examining the impact of potential actions on future outcomes or scenario analysis). The Forecast tool allows a user to look at alternate futures and consider ways of adjusting business performance to influence an outcome.

In embodiments, Forecast provides a prediction for a metric 2140 in light of the state of the rest of the driver graph (i.e., the remaining nodes). In FIG. 21B, Forecast analysis may comprise predicting a parent node metric 2140 based on existing parent data across other nodes (i.e., Prophet modeling). Alternatively, Forecast may designate specific nodes as independent variables and predict those independent variables using a single node forecast. Additionally, Forecast may generate a full graph history, using a Bayesian approach, and predict the value of a specific parent node. The use of a Bayesian approach also allows a user to “fill in the blanks” when data is missing, such as by looking at conditional probabilities and occurrences in past performance and events. From these analyses, Forecast may in turn provide insights to a user based on the predictive analysis described above.

According to embodiments, the systems and methods described herein may comprise a module for generating graphical representations of organizational nodes, which may take the form of a driver graph. The driver graphs disclosed herein preferably allow a user to efficiently and conveniently model or map an enterprise(s) functions, performance, or metrics. In embodiments, a driver graph module may be provided, which further comprises means for graphically presenting to the user the model or map of the enterprise and enable a user (i.e., an analyst) to more readily observe and appreciate the cause or causes driving a specific business function/performance/metric. The module may further include the ability to depict multiple enterprises in a single driver graph interface, or by layering the driver graph interfaces of multiple enterprises. Variations on the nature of the driver graph interfaces is contemplated and described in further detail herein.

In one embodiment, the systems and methods described herein comprise at least one module for automatically providing the user with suggestions or recommendations. This module may be activated by the user, or alternatively running in the background while the user is engaged in any of the foregoing activities. By way of example, this recommendation engine may comprise a periodic search of a data set or reported data and suggest further action by the user. For instance, the suggestion may comprise creation of a new comparison of related data sets, or generation of additional reports and projections to augment the previously supplied business intelligence. In other instances, the recommendation engine searches a library or other repository for similar reports, and then identifies particular business intelligence supplied with those similar reports but not incorporated into the presently supplied report. In another embodiment, the recommendation engine may suggest alternative routines or process from those selected or requested by the user.

In one embodiment, the recommendation engine may serve as a launching point for a user interested in creating a particular type of metric. In this embodiment, the module may further comprise a rules engine, wherein the rules query the user and then search the repository for the type of metric desired by the user.

Through the use of dynamic user interfaces, the AVA is able to present extensive enterprise data in an auditable and transparent fashion, enabling the user to inspect the nodes (and their interrelated topology) to recognize and appreciate patterns, and understand the logic behind the enterprise nodes. The nodes may be depicted according to one of several categories, including by way of example: collapsed; uncollapsed; mapped; unmapped; scanned; unscanned; normal; abnormal; potential anomaly; anomaly; affiliated; unaffiliated; orphan; and other categories. Each category may be represented by a shape, color, pattern, image or other indicia.

Potential anomalies may be easily identifiable, such as by displaying particular nodes with the shape, color or other indicia associated with the potential anomaly category. Here, the potential anomalies are shown in yellow, which is easily distinguishable from the other nodes. The user may quickly identify not only the potential anomalies in the module interface, but can also see which nodes those potential anomalies are interrelated to. In this manner, the user may detect the business performance issues that assist in identifying and underpin the root-cause of any identified anomalies.

A user may be provided with additional node information in summary or other fashion, such as in a legend or other table. In certain embodiments, the user can manipulate the data to change the way the nodes are displayed and/or the additional information provided through the module interface(s). A user may be able to view the underlying assumptions, rules and methodologies employed by the AVA to derive the module interface(s). A user may confirm or correct information relied upon, thereby improving upon the module's capability to display information in a desirable and/or usable format.

By applying established rules and methodologies to the one or more nodes, the AVA described herein may display one or more driver graphs to the user for better understanding and interpreting the different nodes and their characteristics, including how those nodes are influenced by other nodes of the enterprise. Through use of the module interface(s), a user may quickly map or model the complete business performance of an enterprise, and visualize the interrelated nodes (preferably depicted graphically in a manner described below) that enables the user to recognize the influencing factors within an enterprise that need to be addressed, and grasp the root cause of any business performance issue. For instance, nodes may be depicted as enlarged or attractively hued compared to other nodes if a certain metric is found by the AVA to be met (or alternatively, not met). The callout of a particular node makes it easier for the user to identify the critical area of the enterprise, and then drive down into related nodes to determine the root cause of the associated rule being true (or false, as the case may be). By representing the various nodes of the organization graphically via the module interface(s) described herein, a user has much greater visibility into an enterprise.

By way of example but not limitation, a module interface(s) may include a historical performance aspect, and represent nodes in a manner that permits the user to quickly identify areas of the enterprise that are not functioning true to historical norms. Alternatively, the module may identify anomalies in the performance of the enterprise, which are displayed by the interface(s) in a manner to permit a user to quickly identify the critical information needed to timely process business decisions for addressing those anomalies.

The module interface(s) preferably provide the user with the ability to drill down into any particular node and explore the related nodes to identify key drivers of the problem or issue encountered by the enterprise. In this manner, the interface provides the user with the ability to audit each underlying node and business data surrounding that node to determine a next course of action, and if appropriate make a correction to the model. In certain embodiments, the driver graph module (alone or in connection with one or more AVA as described above) can offer suggestions of where to begin auditing nodes if multiple issues are identified by the system. In other embodiments, the driver graph module may immediately flag or alert the user of the most critical issues within a certain classification (i.e., anomalies), and thereby provide the user with a prioritized task list of issues to address.

Various user interfaces, reports and displays are also the subject of this disclosure. The user interfaces may comprise a display for viewing data or data representations via a mobile device, such as a smart phone, tablet or laptop style computing device. The user interface may comprise an interactive dialog display, which may be in the form of a dialog box, window or equivalent. The user interface may be configured to automatically resize and reformat the interactive dialog display depending on the viewable area of the device on which the user interface is displayed. The user interface may also accommodate a variety of communication modalities, including both written and oral communication.

Referring now to FIGS. 22-27, the systems and methods described herein, including the driver graph module, preferably include the ability to run reports and provide a summary of the nodal hierarchy without divulging the entire model or map to another person. For instance, in certain embodiments the module has the ability to generate reports with a summary of the root causes identified from the modeling performed, the actions taken or recommended in light of the identified root causes, and a predictive analysis of when those issues are likely to recur, and where within the node cluster, layer or map related issues are likely to arise. The interfaces may further include a dialog display, which permits the one or more AVA to interject with suggestions, recommendations or answers to queries posed by the user while interpreting the information displayed through the module interface. As indicated above, the AVA may simultaneously be performing other tasks to assist the user in breaking down the root cause of one nodal issue while the user visually explores the transparent layers of an anomaly associated with a different node structure.

Referring in detail to FIG. 26, several nodes having interrelationships or connections may be displayed via the module interface(s) as a cluster. In these instances, the module display may present those clustered nodes in a manner to enhance independent selection and extraction of critical information associated with any single node. Further, the module may provide the user with multiple layers, whereby nodes that exist in certain layer of the enterprise are shown connected to nodes of a different layer, but which nonetheless may be easily recognized by the user through the module interface. Once recognized, the user may be provided with the ability to drive down or up through the enterprise and view connected nodes on a different layer. In one embodiment, the module interface(s) permits a user to hover over a node and receive a prompt or visual que that a node contains interrelated of connected nodes at a different layer. On other embodiments, a larger sized node may indicate to the user that other nodes exist that are related to that larger node, either above or below within the organizational hierarchy. Variations on these different ways of displaying node relationships and connections are contemplated.

The driver graph module may display multiple node clusters and multiple layers of nodes simultaneously. The user is preferably provided with the ability to select and zoom into a particular node cluster or layer as desired, and the interface is designed to respond intuitively to the user's directions. In certain embodiments, the AVA and natural language dialog features describe above further enhance the user's ability to issue verbal commands and the module will modify the interface(s) accordingly. The module is oriented to integrate with the AVAs functionality, including the machine-learning capabilities, for the purpose of adapting the model autonomously. In this manner, the module may convert the AVA into an adaptive, learning system for modeling an enterprise hierarchy or architecture. This system may evolve as the business enterprise evolves and new business conditions or events occur, ensuring continued optimal performance of both analytical and forecasting tasks.

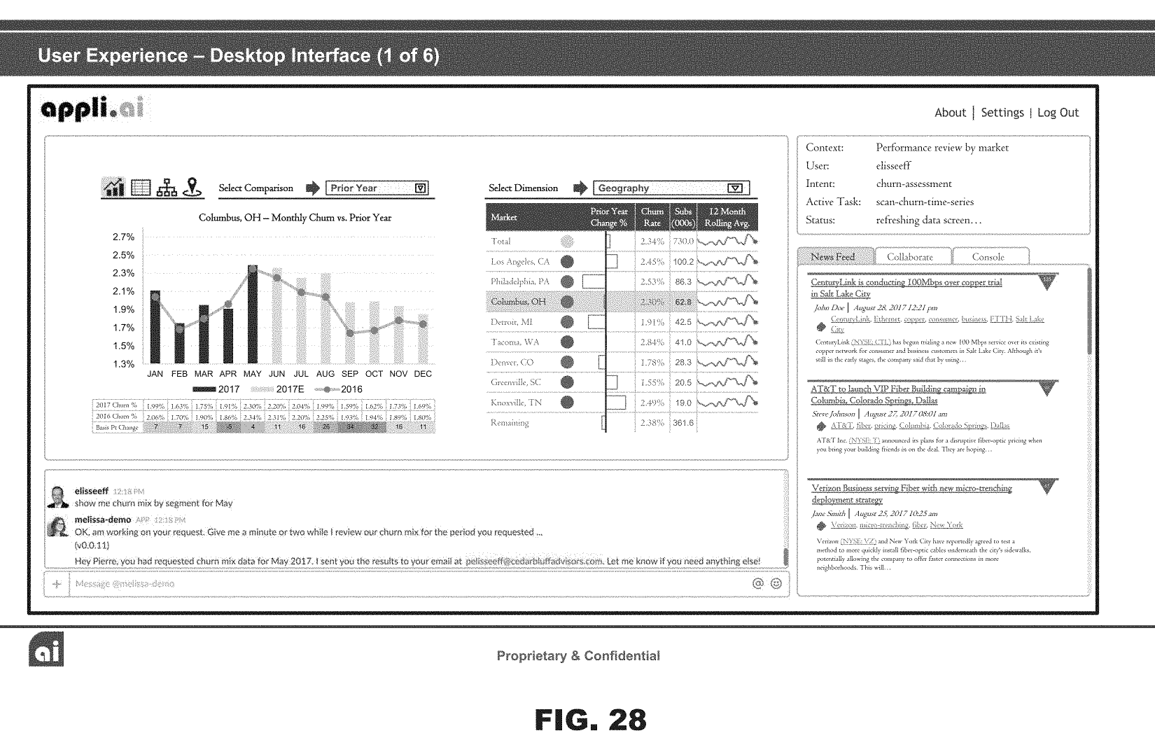

The user interface(s) referred to herein may take many forms. For example, the user interface and dialog display shown in FIGS. 28-31 includes additional benefits for a user. In these embodiments, the user interface includes multiple panes for displaying information to the user simultaneously and in near real-time (if not real-time). The dialog display may be truncated and located below a reporting display, as shown in FIG. 28. The reporting display may comprise status related information, and in one embodiment show the meta-data input/output of the various AVAs at work. A visualization display may also be provided on one side of the user interface, which may comprise details relating to the assessment or process currently under review by the AVA(s), contextual information for review and confirmation by the user, and any data that may be helpful to the user or otherwise facilitate the inquiry, instruction or command interaction with the AVA(s). Variations and combinations (including sub-combinations) of the foregoing are contemplated for use with the present disclosure.

During use of the user interface, a user may in put an inquiry, instruction or command. The AVA is configured to interpret the user's inquiry, instruction or command and take steps depending on the nature of the inquiry, instruction or command. In embodiments, the AVA is not only able to interpret and access data from one or more data repositories to return the business of financial information the user desires, but comprises intelligence capability for establishing the logic and data necessary to return a positive result for the user. In certain embodiments, the AVA establishes the logic and hierarchy between separate but related business data or metrics and performs pattern comparison and matching to classify data or metrics in order to provide a more detailed analysis. In embodiments, the AVA also comprises a module for performing pattern recognition, enabling the AVA to identify trends and make projections based on current data in a data repository.

Each AVA may have access to a plurality of data repositories including a data repository of phrase constructs; a customer-relationship management (CRM) data repository; and a business knowledge data repository. The AVA may work with other AVAs to coordinate multiple tasks or consolidate activity across multiple business and financial data repositories. Further, embodiments of the foregoing disclosure may be configured or adapted for use with multiple, distinct enterprises, and may comprise a model of one or more business intelligence queries in the form of a logic or driver graph.

In embodiments, a driver graph may be configured for use by the AVA relating to the particular context of the inquiry or request of the user. In embodiments, several different contextual AVAs may be supplied simultaneously, each AVA configured specifically for one or more driver graphs. Each driver graph preferably comprises a plurality of nodes, wherein each node may comprise a logical routine, a sub-routine, an input function, an output function, and equivalent processes. Each node may comprise multiple of the foregoing exemplary processes. Furthermore, context and meaning may be maintained during a dialog through the use of one or more nodes in a driver graph, which may further comprise the structure of a task to be performed jointly through user-AVA dialog, and an execution model for conducting a dialog between the user and the AVA to maintain appropriate context and result in successful completion of the desired activity.

In embodiments, the AVA may be further configured to determine whether any additional information is required to complete a task or fulfill a query. If a determination is so made, the AVA is configured to generate prompts for each piece of missing information from a user.

Through use of machine learning and deep neural networks (through which multiple AVA may share information), rules and methodologies may be better refined and adapted to suit a particular user's needs or an organization's preferences. For example, the module may display textual information when the module interface becomes too dense or difficult to manipulate, and thereby provide the user with a set of instructions for interpreting the data and finding the most relevant nodes for the problem the user is trying to solve. As another example, the user may be provided with the logical relationships or patterns that the AVA is able to discern through processing the enterprise data and preparing the module interface(s), which in turn may permit the user to better understand the data being presented.

As touched upon above, an AVA may interact with a user in an intelligent and conversational manner to obtain and confirm an inquiry, instruction or command through the use of, by way of example but not limitation, artificial intelligence, ontological semantics, natural language processing, automatic speech recognition, dialog management, context management and other system components described in detail herein. A combination of the foregoing may also be employed by the AVA(s) described herein. In embodiments, one or more AVAs may be selected based on the interpreted command or request. The AVA may comprise an artificial intelligence module, a Bayesian inference module and/or a decision tree module, and may have an adaptive learning and/or deep neural network learning engine.

In embodiments described herein, the system may comprise a module for natural language processing. In embodiments, the system may further comprise a module for foreign language processing, and may comprise a language identification module configured to determine a language to be associated with a particular user. The system may comprise additional modules, including but not limited to a communication analysis module, a speech to text module, and a voice analysis module. The system may be configured to receive the at least one input and translate each of the at least one inputs into a native language before processing the inquiry, instruction or command.

A speech biometric engine may be supplied if data security is required for access to the requested data wherein, if the user is recognized, the AVA may select a decision tree associated with the user and extract the requested information from a secure data repository. If the user is not recognized, the AVA may terminate the dialog session or provide messaging to one or more other authorized users to report the potential breach.

The system may be configured to produce a written transcript of the dialog between the AVA and the user, and in certain embodiments displayed in real-time or near real-time to the user for the purpose of (1) providing the user with the ability to identify and correct misinterpretation of an orally communicated command, (2) provide the user with a historical record of the inquiry(ies) and responses supplied during the dialog, and (3) instruct the AVA(s) with respect to any satisfactory and/or unsatisfactory responsive information for future adaptation.

One or more AVA(s) may engage in dialog with a user through known written communication modalities, including direct messaging, text messaging, electronic mail, slack, and other messaging formats. The textual exchange between a user and an AVA may appear in a running dialog stream, and in certain embodiments include icons or other indicia to represent the user and/or AVA engaging in the dialog. For example, a AVA may be identified using a standard naming convention, determined from the functionality or capability of the AVA, or may have a user-selected name or similar identity. The user may be identifiable through the user identification name, a user-selected icon or image (i.e., photograph), the user's avatar, etc. As dialog continues the display preferably scrolls to maintain the most recent dialog visible to the user, while less recent dialog scrolls off the display. In certain embodiments, the dialog is archived for later viewing by the user. In other embodiments, the user may scroll to any previous dialog using the user interface, and may search, sort or filter the dialog using one or more user interface add-ons provided with the system.

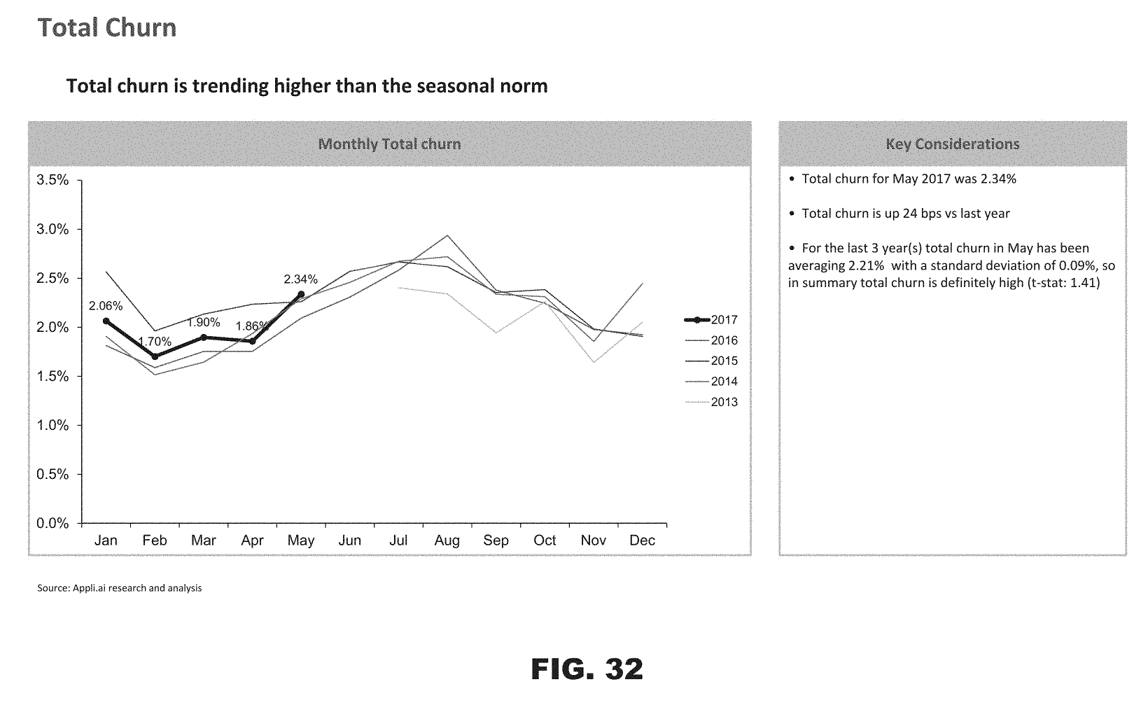

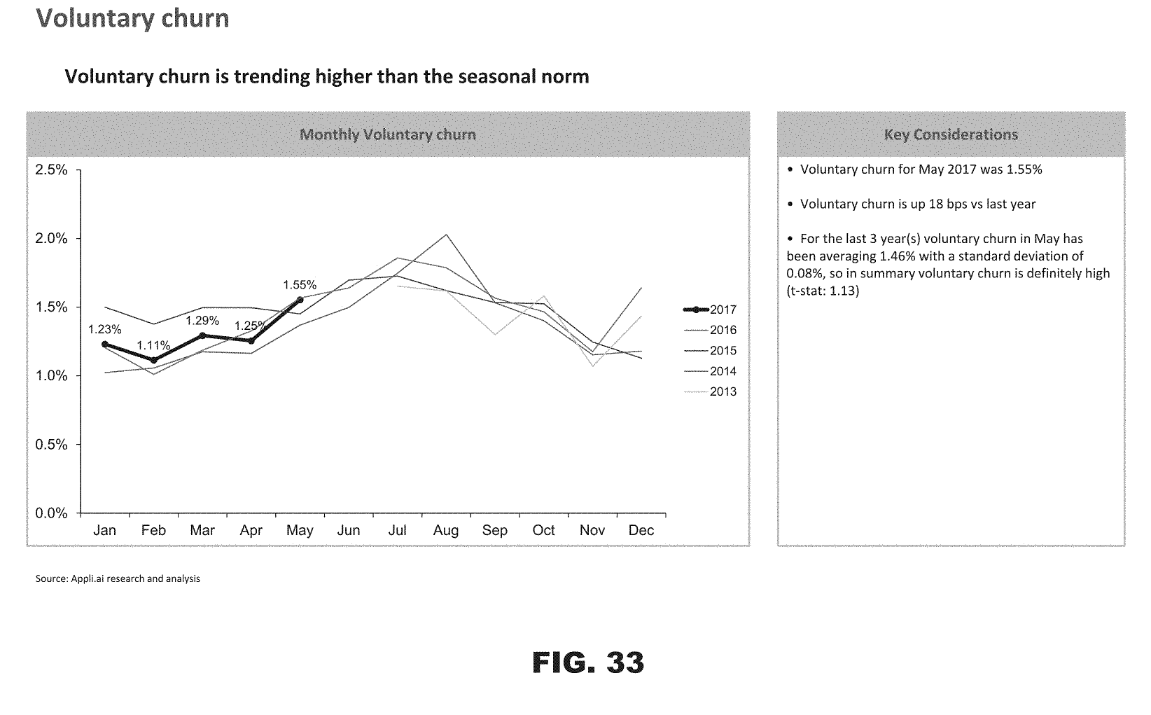

Embodiments further include the ability to generate reports, which may incorporate insights as described above. In varying embodiments, reports generated by the AVA(s) may take on many forms, including those exemplary reports shown in FIGS. 32-42 appended hereto. According to embodiments, one type of analysis that an AVA is configured to provide is related to “churn” and may be visually presented to a user in one of several forms. For example, as shown in FIG. 32, one report may show total churn on a monthly basis, comparatively over the course of several years. As shown in FIG. 33, “voluntary churn” may be shown along with graphical or textual representation of historical or recent trends.

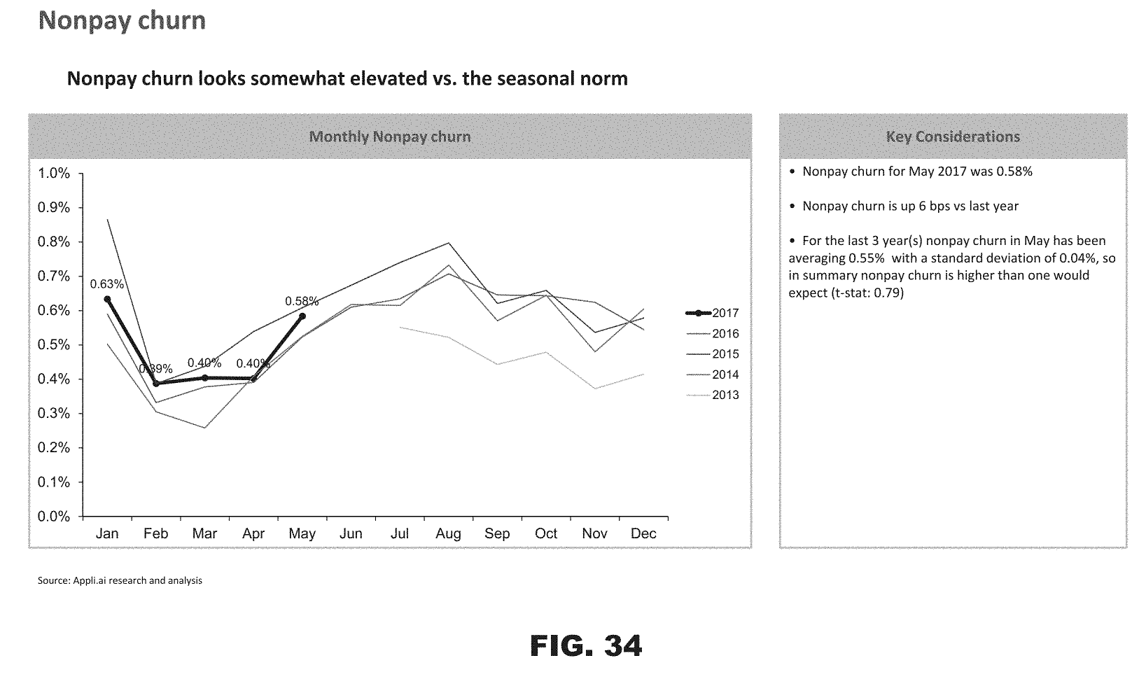

Referring to FIGS. 34-42, other reports may comprise graphical and/or textual information relating to “nonpay” churn, churn by market, geographic-specific churn, churn mix by segment, churn mix by income group, churn mix by home ownership classification, churn mix by dwelling type, and churn mix by ethnicity. Reports may also include analysis, such as key considerations, as shown in FIGS. 32-37. It is to be understood that these Figures represent exemplary reports only, and that additional analysis and reports may be supplied given the tasks assigned to one or more AVAs.

The system is also preferable configured to provide alerts. Alerts may be provided AVA the application (e.g., notification upon login, push notification), email, messaging, or any other suitable method of communication to the user. Alerts may be defined for certain conditions, for example, modification occurring to one or more decision trees, access and reporting with respect to one or more data repositories, etc. Alternately, alerts may be provided for approval by a primary user. For example, alerts may be provided based on a particular user accessing a AVA, or based on a user completing a decision tree with a particular AVA. In some examples, an alert may indicate a recommended course of action.

The application/modules are preferably configured to run on a computer server or similar computational machinery. The system and modules may be stored or operated on a computing environment, wherein the devices, servers, modules, etc. may execute. The computing environment preferably includes one or more user computers. The computers may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems.

User computers may also have any of a variety of applications, including for example, database client and/or server applications, and web browser applications. Alternatively, the user computers may be any other electronic device, such as a thin-client computer, Internet-enabled mobile telephone, and/or personal digital assistant, capable of communicating AVA a network and/or displaying and navigating web pages or other types of electronic documents. Any number of user computers may be supported.

The computing environment described according to this embodiment preferably includes at least one network. The network can be any type of network familiar to those skilled in the art that can support data communications using any of a variety of commercially-available protocols, including without limitation SIP, TCP/IP, SNA, IPX, AppleTalk, and the like. Merely by way of example, the network maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system in varying embodiments may also include one or more server computers. One server may be a web server, which may be used to process requests for web pages or other electronic documents from user computers. The web server can be running an operating system including any of those discussed above, as well as any commercially-available server operating systems. The web server can also run a variety of server applications, including SIP servers, HTTP servers, FTP servers, CGI servers, database servers, Java servers, and the like. In some instances, the web server may publish operations available operations as one or more web services.

According to certain embodiments, the computing environment may also include one or more file and or/application servers, which can, in addition to an operating system, include one or more applications accessible by a client running on one or more of the user computers. The server(s) may be one or more general purpose computers capable of executing programs or scripts in response to the user computers. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) may also include database servers, including without limitation those commercially available from Oracle, Microsoft, Sybase™, IBM™ and the like, which can process requests from database clients running on a user computer.

In embodiments, the web pages created by the application server may be forwarded to a user computer AVA a web server. Similarly, the web server may be able to receive web page requests, web services invocations, and/or input data from a user computer and can forward the web page requests and/or input data to the web application server. In further embodiments, the server may function as a file server. Although the foregoing generally describes a separate web server and file/application server, those skilled in the art will recognize that the functions described with respect to servers may be performed by a single server and/or a plurality of specialized servers, depending on implementation-specific needs and parameters. The computer systems, file server and/or application server may function as an active host and/or a standby host.

In embodiments, the computing environment may also include a database. The database may reside in a variety of locations. By way of example, database may reside on a storage medium local to (and/or resident in) one or more of the computers. Alternatively, it may be remote from any or all of the computers, and in communication (e.g., AVA the network) with one or more of these. In a particular embodiment, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, which is adapted to store, update, and retrieve data in response to SQL-formatted commands.

The computer system may also comprise software elements, including but not limited to application code, within a working memory, including an operating system and/or other code. It should be appreciated that alternate embodiments of a computer system may have numerous variations from that described above. For example, customized hardware might also be used and/or particular elements might be implemented in hardware, software (including portable software, such as applets), or both. Further, connection to other computing devices such as network input/output devices may be employed.

According to one embodiment, the server may include one or more components that may represent separate computer systems or electrical components or may software executed on a computer system. These components include a load balancer, one or more web servers, a database server, and/or a database. The load balancer is operable to receive a communication from the mobile device and can determine to which web server to send the communication. Thus, the load balancer can manage, based on the usage metrics of the web servers, which web server will receive incoming communications. Once a communication session is assigned to a web server, the load balancer may not receive further communications. However, the load balancer may be able to redistribute load amongst the web servers if one or more web servers become overloaded.

In embodiments, one or more web servers are operable to provide web services to the user devices. In embodiments, the web server receives data or requests for data and communicates with the database server to store or retrieve the data. As such, the web server functions as the intermediary to put the data in the database into a usable form for the user devices. There may be more or fewer web servers, as desired by the operator.

In this embodiment, a database server is any hardware and/or software operable to communicate with the database and to manage the data within the database. Database servers, for example, SQL server, are well known in the art and will not be explained further herein. The database can be any storage mechanism, whether hardware and/or software, for storing and retrieving data. The database can be as described further herein.

In embodiments, the system may comprise an adaptive learning capability wherein, if a relationship between the at least one input and the decision tree node cannot be determined, a machine learning engine is further provided and configured to process the at least one input. By way of example but not limitation, embodiments disclosed herein further comprise the ability to generate one or more nodes associated with a decision tree. The system further comprises the ability to either manually pre-populate a set of nodes or automatically create a set of nodes for the new decision tree. In embodiments, the new decision tree may be associated with a particular business-specific data repository. Embodiments disclosed herein include receiving an input and associating a set of inputs to one or more nodes in the new decision tree. The new decision tree may be based upon a template created by a user.

In the foregoing description, for the purposes of illustration, systems and methods were described in a particular order. It should be appreciated that in alternate embodiments, the methods may be performed in a different order than that described. It should also be appreciated that the methods described above may be performed by hardware components or may be embodied in sequences of executable instructions on machine-readable media, and which cause a machine, such as a general-purpose or special-purpose processor or logic circuits programmed with the instructions to perform the methods. These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted AVA any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A system for autonomously organizing and analyzing data associated with an organization, comprising:
a data source;
a processor operating on specially configured computational machinery, wherein the processor is programmed to:
retrieve structured data from the data source; and
transform the data to comport with a predetermined dataset format;
a dimensional hierarchy database comprising one or more rules;
a primary graph generation module, comprising:
a mapping function, wherein the mapping function assigns the transformed data to nodes;
a linking function, wherein the linking function extracts information from the dimensional hierarchy database for determining the hierarchy of the nodes and relationships between the nodes;
a graphing function, wherein the graphing function associates the nodes into an initial primary graph based on the mapping and linking functions;
a structure learning function, wherein the primary graph generation module is configured to regenerate the initial primary graph based upon at least one of: a change in the dimensional hierarchy database; a change occurring in the transformed data; an error determination made by the primary graph generation module; or, an instruction to validate the initial primary graph;
an inflation function, wherein the initial primary graph is inflated by incorporating additional datasets to create a complete graph, and wherein the complete graph is based upon the mapping and linking functions completed for the initial primary graph.

2. The system of claim 1, wherein the predetermined dataset format comprises a period, at least a first dimension and at least a first metric.

3. The system of claim 2, wherein the at least a first dimension comprises one or more dimensional levels.

4. The system of claim 2, wherein the processor is further programmed to retrieve unstructured data from the data source.

5. The system of claim 1 further comprising an application server in communication with the primary graph generation module.

6. The system of claim 5, wherein the application server is in communication with a display server configured to display at least a portion of the initial primary graph or a portion of the complete graph to a user through one or more user interfaces.

7. The system of claim 1 further comprising an analytics engine, the analytics engine comprising a correlation tool for analyzing future behavior of one or more nodes.

8. The system of claim 1 further comprising an anomaly detection function, wherein the anomaly detection function is configured to detect an unexpected state of at least one node in comparison to the retrieved structured data of the at least one node and the structure of the complete graph.

9. The system of claim 8, wherein the anomaly detection function is configured to perform root cause focusing by identifying and evaluating potential causes of the unexpected state of at least one node at a predetermined distance removed from the at least one node in relation to the complete graph.

10. The system of claim 1 further comprising a forecasting engine, the forecasting engine configured to predict outcomes based upon one or more nodes in the complete graph.

11. A method for autonomously managing data, comprising:
accessing, by a processor, data from a data source;
transforming the data into a plurality of datasets;
determining a hierarchy for the data contained in the plurality of datasets;
mapping, by the processor, data from the plurality of datasets to a plurality of nodes;
linking, by the processor, one or more nodes of the plurality of nodes based upon information from the determined hierarchy;
graphing, by the processor, the plurality of nodes based upon the mapping and linking steps into an initial graphical format;
inflating, by the processor, the initial graphical format into a complete graphical format by incorporating additional datasets into the initial graphical format.

12. The method of claim 11 further comprising the step of learning, by the processor, errors in the initial or complete graphical format, and further comprising the step of making corrections to the initial or complete graphical format.

13. The method of claim 11 further comprising the step of detecting anomalies in the initial or complete graphical format.

14. The method of claim 13, wherein the step of detecting anomalies comprises comparing at least one of the plurality of nodes in to historical data associated with the at least one of the plurality of nodes, and further comprises evaluating potential root causes a distance away from the at least one of the plurality of nodes relative to the structure of the initial or complete graphical format.

15. The method of claim 12 further comprising the step of analyzing correlations between two or more of the plurality of nodes.

16. The method of claim 15, wherein the step of analyzing correlations comprises evaluating the future behavior of at least one of the plurality of nodes.

17. The method of claim 12 further comprising the step of forecasting, wherein the forecasting step comprises generating potential outcomes based upon the behavior of nodes in the complete graphical format.

18. The method of claim 11, wherein the datasets result from transformation of structured and unstructured data.

19. The method of claim 11, wherein the datasets comprise at least one period, at least one dimension and at least one metric.

20. The method of claim 11 further comprising the step of displaying, to a user, the initial or complete graphical format.
